(19) United States
(12) Patent Application Publication
(10) Pub. No.: US 2026/0370750 A1
(43) Pub. Date: Nov. 19, 2026

(54) PREDICTING USER LOCATION AND CONTEXT WITH PRIVACY-PRESERVING PERSONALIZED INTELLIGENCE

(71) Applicant: Apple Inc., Cupertino, CA (US)

(72) Inventors: Kevin W. Watts, Mountain View, CA (US); Benjamin A. Werner, San Jose, CA (US); Brent M. Ledvina, San Francisco, CA (US)

(73) Assignee: Apple Inc., Cupertino, CA (US)

(21) Appl. No.: 19/648,797

(22) Filed: Apr. 15, 2026

Related U.S. Application Data
(60) Provisional application No. 63/808,365, filed on May 19, 2025.

(51) Int. Cl. H04M 1/72415; H04W 4/02; H04W 4/024; H04W 4/029

(52) U.S. Cl. CPC H04M 1/72415; H04W 4/023; H04W 4/024; H04W 4/027; H04W 4/029

(57) ABSTRACT

An electronic device can predict future user locations using a variety of different inputs from the device's sensors and applications. The inputs can include information about the electronic device's location over a historical time period, and the device can use the location information to generate a location model. This model can be generated at regular intervals (e.g., nightly), and between intervals, the device can monitor the sensors and applications for data. The monitored data can be used to detect triggers and update the location model. Responsive to the triggers, the electronic device can predict one or more future user locations for future time intervals using the model, a current time, and the monitored data. The electronic device can use the predicted future locations to perform operations such as providing the predicted locations in a notification or beginning navigation to a future location.

### CROSS-REFERENCES TO OTHER APPLICATIONS

This application claims priority to U.S. Provisional Application No. 63/808,365, for “PREDICTING USER LOCATION AND CONTEXT WITH PRIVACY-PRESERVING PERSONALIZED INTELLIGENCE” filed on May 19, 2025, which is herein incorporated by reference in its entirety for all purposes.

### BACKGROUND

Electronic devices can perform different functionality to assist the device's user. However, this functionality may be triggered by user requests, and the electronic device may not take certain actions without user input. As a result, certain functionality may be difficult to use because its use depends on the user's memory and attention. An electronic device would be easier to use with more proactive actions that do not require user input. For example, the device may be more useful with adaptable user interfaces or automated functionality that can adapt to different situations without user input. Accordingly, improvements to proactive actions by an electronic device are desirable.

### BRIEF SUMMARY

A model for location predictions can be generated using data about the electronic device's movement and use. This information is potentially sensitive, and the device user's privacy can be improved by generating the model on the electronic device. Disclosed techniques can enable model generation/training on the electronic device. Or dynamic adjustment of a model can be improved to provide dynamic updates and functionality for models, even for models trained on a server and/or running on a server.

An electronic device can predict future user locations using a variety of different inputs from the device's sensors and applications. The inputs can include information about the electronic device's location over a historical time period, and the device can generate one or more location models using the location data. In some embodiments, a model may be generated using inputs from a geographical region, and the resulting model may be used to make predictions within the bounding box. The one or more models can be generated at regular intervals (e.g., nightly), and the device can monitor the sensors and applications for data between intervals. The monitored data can be used to detect triggers and update the location model. Responsive to the triggers, the electronic device can predict one or more future user locations for the device using the model, a current time, and the monitored data. The electronic device can use the predicted future locations to perform operations such as providing the predicted locations in a notification or beginning navigation to a future location. The electronic device may take various actions in response to the notifications.

The techniques may include measuring location information of the mobile device over a historical time period. The location information may be measured using one or more location protocols. The techniques may also include determining a set of visited locations for use in an output layer of a location model. The set of visited locations may be determined using the location information. The techniques may furthermore include generating the location model using the location information. The techniques may in addition include receiving a trigger to perform a location inference using the location model. The techniques may moreover include determining, from data stored on the mobile device, one or more current location-related data items. The techniques may also include predicting one or more future locations of the mobile device over one or more future time intervals using the location model, one or more current location-related data items, and a current time. Other embodiments may include corresponding computer systems, apparatus, and computer programs recorded on one or more computer storage devices, each configured to perform the actions of the techniques.

The techniques may include measuring location information of the mobile device over a historical time period using one or more location protocols. The location information can include history-based visits and scheduled visits. The techniques may also include generating a first location model using the history-based visits. The techniques may furthermore include generating a second location model using the scheduled visits. The techniques may in addition include receiving a trigger to perform a location inference using the first location model and the second location model. The techniques may moreover include predicting one or more first future locations of the mobile device over one or more future time intervals using the first location model and a current time. The techniques may also include predicting one or more second future locations of the mobile device over one or more future time intervals using the second location model and the current time. The techniques may furthermore include combining the one or more first future locations and the one or more second future locations to determine one or more final future locations over the one or more future time intervals. Other embodiments may include corresponding computer systems, apparatus, and computer programs recorded on one or more computer storage devices, each configured to perform the actions of the techniques.

The techniques may include measuring location information of the mobile device over a historical time period using one or more location protocols. The techniques may also include generating a location model using the location information. The techniques may furthermore include storing a set of triggering events having specified criteria. The techniques may in addition include monitoring at least one of a group having of geographical locations, navigation, or motion of the mobile device, thereby obtaining monitored data. The techniques may moreover include determining that the monitored data satisfies one or more of the specified criteria. The techniques may also include predicting one or more future locations of the mobile device over one or more future time intervals using the location model and a current time. Other embodiments may include corresponding computer systems, apparatus, and computer programs recorded on one or more computer storage devices, each configured to perform the actions of the techniques.

The techniques may include determining the mobile device is within a geographical region. The techniques may also include measuring, using one or more location protocols, location information of the mobile device over a first historical time period. The techniques may furthermore include generating a location model using the location information. The techniques may in addition include predicting one or more future locations of the mobile device over one or more future time intervals using the location model. The techniques may moreover include determining the mobile device is still within the geographical region. The techniques may also include updating the location model using updated location information measured while the mobile device is within the geographical region. The techniques may furthermore include determining the mobile device is outside the geographical region. The techniques may in addition include suspending updating the location model while the mobile device is outside the geographical region. Other embodiments of this aspect include corresponding computer systems, apparatus, and computer programs recorded on one or more computer storage devices, each configured to perform the actions of the techniques.

The techniques of this disclosure can be implemented as methods, systems, non-transitory computer readable mediums, and devices. In some embodiments, the techniques can be performed by an electronic device that includes one or more processors and a memory. The memory can be coupled to the one or more processors, and the memory can store instructions that cause the one or more processors to perform the techniques.

The techniques of this disclosure may be implemented using a non-transitory computer readable medium. The medium can store instructions that can be executed by one or more processors to perform any of the techniques.

### BRIEF DESCRIPTION OF THE DRAWINGS

FIG. 1 shows a simplified high-level diagram of a location prediction architecture, according to various embodiments.

FIG. 2 is a simplified diagram of an architecture for generating initial location predictions, according to various embodiments.

FIG. 3 is a simplified diagram of an architecture for updating initial location predictions, according to various embodiments.

FIG. 4 is a flowchart illustrating a method for predicting future locations, according to various embodiments.

FIG. 5 is a flowchart illustrating a method for predicting future locations using historical and scheduled location information, according to various embodiments.

FIG. 6 is a system diagram showing an architecture for event driven triggers according to various embodiments.

FIG. 7 is a flowchart illustrating a method for predicting future locations using event-driven triggers, according to various embodiments.

FIGS. 8A-8C are simplified diagrams 801, 803, and 805 showing geographically bound location prediction models according to various embodiments.

FIG. 9 is a flowchart illustrating a method for predicting locations using a geographic specific location model, according to various embodiments.

FIG. 10 illustrates a system and a process for generating a familiar route 1012 for a user, according to certain embodiments.

FIG. 11 shows a technique for training a machine learning model, according to at least one embodiment.

FIG. 12 shows an example machine learning model of a neural network, according to at least one embodiment.

FIGS. 13A-13F show example application programming interfaces (APIs), according to at least one embodiment

FIG. 14 is a block diagram of an example electronic device, according to at least one embodiment.

### DETAILED DESCRIPTION

A model for location predictions can be generated using data about the electronic device's movement and use. This information is potentially sensitive, and the device user's privacy can be improved by generating the model on the electronic device. Generating a location model on the electronic device may not be practical during the device's regular use because model generation be time consuming and computationally demanding. However, many electronic devices are used at a regular cadence, and, for example, a mobile device may be used during waking hours and charged nightly. This predictable schedule can allow an electronic device to locally generate a model during charging, when power and resource consumption is less constrained, and use the model between charges. Periodic model generation can mean that inputs may change between the model's generation and the model use to make predictions. The model's accuracy can be improved by updating the model as the inputs change between periodic model generations. The model can be updated at regular intervals or in response to event based triggers.

Embodiments can include techniques to periodically generate a location prediction model using location information. Location information can be measured between the periodic model generations, and this information can be used to dynamically update the model. Embodiments can include generating multiple disparate models to make location predictions. The output of the different models can be averaged to produce the final model predictions. Some embodiments may include dynamically updating the model using event-driven triggers. The updates may be triggered in response to detecting a change in the location information. The embodiments may include generating a location model that is specific to geographic area that is defined by a geographical region. The model may be trained on data from within the bounding box, and a mobile device may use the model to make predictions when the device is inside of the geographical region. The description begins with an overview before the individual embodiments are discussed in greater detail.

### I. Overview

Generating the location model may include generating a model that outputs initial location predictions. For example, an initial location prediction can be a probability that the electronic device will travel to a particular destination. The probability for one or more most likely locations can be determined for each of a number of predetermined future time intervals. The initial prediction model may be generated when the device is stationary and charging. However, updated predictions may be desirable because the likelihood of the initial location predictions can change as the device moves with the user between model generations. The electronic device measure information throughout the day, and the measured information can be used to update the location model when a prediction trigger is detected. For example, a trigger can be detected when an electronic device leaves a known location, and the device's trajectory after leaving can be used to update the initial location prediction model. In this example, the probability for an initial location prediction may be increased if the device's trajectory shows movement towards the location.

### A. Initial Location Predictions

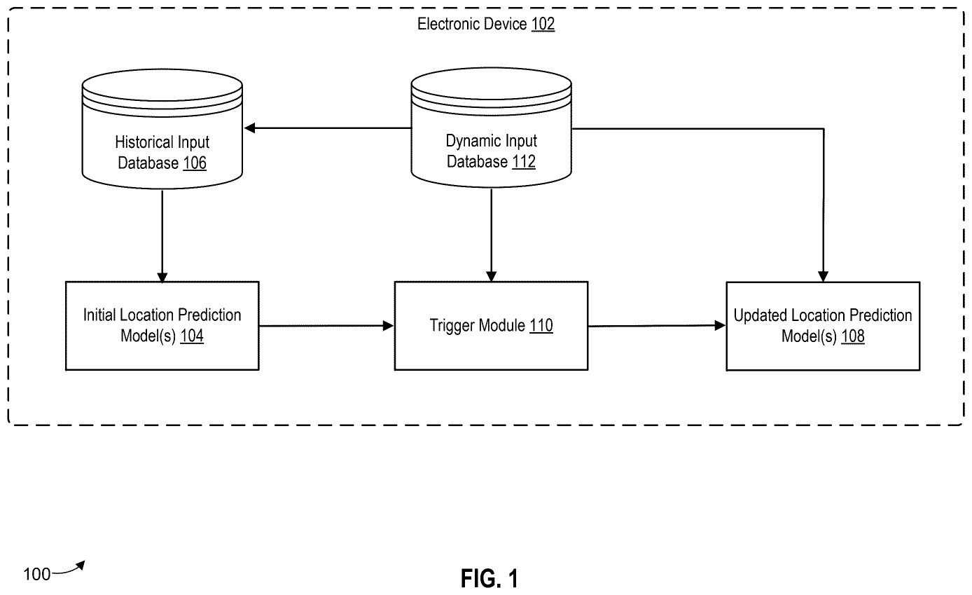

FIG. 1 shows a simplified high-level diagram of a location prediction architecture 100, according to various embodiments. The prediction architecture can be implemented by an electronic device 102, and the device 102 can use the architecture to cyclically produce and update location predictions. In a first part of a prediction cycle, the electronic device 102 can produce one or initial location prediction model(s) 104. The training of one or initial location prediction model(s) 104 can be performed when the device's use is minimal. For example, a device's user may charge the electronic device 102 while the user is sleeping, and the electronic device 102 may generate the initial location prediction model(s) 104 when the device is charging overnight.

The electronic device 102 may produce the initial location prediction model(s) 104. Generating a model can be computationally demanding and may include operations to train a machine learning model or to identify statistics for a statistical model. The electronic device 102 may dedicate computing resources to generate the model, and the device may have a reduced capacity for other tasks during model generation. Generating the model when the device is charging and not being used can preserve the device's battery capacity and reduce user downtime.

The initial location prediction model(s) 104 can be generated using data from a historical input database 106 that includes a variety of different inputs across different apps and sensors. The data can include a set of visited locations that are identified from location information that is measured over a historical time period (e.g., 1-12 weeks). An output at an interference stage (which can occurs periodically during the day or in response to certain triggers) can specify a likelihood of a destination during different time intervals, e.g. list the most likely destination at different times during the day. The initial location prediction model(s) 104 training can be run nightly to identify possible destinations for the next day. Such models can include a neural network that can be trained at night (or other time period) can then rerun (e.g., updated) with any new inputs during the day. An inference stage can be triggered periodically or in response to events. At a given inference stage during the day, weights can be assigned based on a current trajectory. Destinations that are too far away removed for certain time periods. Further transit states can be predicted, including certain types of transit states (e.g., walking, biking, driving, on train, etc.).

The initial prediction model(s) can include one or more separate models that are trained on different data. The models can include any combination of any number of a visit history model, a location model, a calendar model, and a scheduled travel model. In some embodiments, a model can be trained for data from a particular geographic region and the model can be trained to make location predictions when the electronic device is within this particular region. The model's predictions may be paused when the device is outside of the particular geographic region. The geographic region can be a neighborhood, a city, a county, a zip code, a state, and a geographic bounding box.

Disparate models may be trained on different categories of data. For example, separate models can be trained on the electronic device's location visit history and the electronic device's scheduled travel. The output from the disparate models can be combined to determine the predicted future locations.

### B. Historical Inputs for Generating Models

The initial location prediction model(s) 104 can be generated using data from a historical input database 106. The data in the historical input database 106 can include a visit history that was measured by the electronic device 102 over a historical time period. The visit history can be a set of visited locations that are determined from location data. The electronic device 102 can measure the location data during the historical time period using one or more location protocols such as GPS, GNSS, triangulation using cellular towers, and connections to network devices at known positions. The historical input database 106 may include data from applications or system processes on the electronic device 102 that can be used to generate the initial location prediction model(s) 104. For example, the data can include calendar events, tickets from a digital wallet, scheduled travel from a maps application, viewed places on a maps application, locations for associated devices, and parked car locations.

### C. Dynamic Updates to Location Predictions

The electronic device 102 may generate updated location prediction model(s) 108 from the initial location prediction model(s) 104 after detecting a trigger using trigger module 110. The initial location prediction model(s) 104 are generated in a first portion of a prediction cycle, and the updated location prediction model(s) 108 during a second portion of the cycle. The electronic device 102 may be stationary and charging during the first portion of the prediction cycle, and the initial location prediction model(s) 104 may be probabilities for locations based on the device's location and activity up to the time when the initial predictions are produced.

The electronic device's movement and activity during the second portion of the prediction cycle may impact the likelihood of the probabilities output by the initial location prediction model(s) 104. The first portion of the prediction cycle may be when the electronic device's user is sleeping, and the second portion of the cycle may correspond to the user's daily activity. The electronic device 102 can measure inputs during the second portion of the cycle and update the initial location prediction model(s) 104 to improve the predictions' accuracy.

The updated inputs can be stored in the dynamic input database 112. The inputs in the dynamic input database 112 can be the same types of data as the inputs in the historical input database 106, and the inputs from the dynamic input database 112 can be periodically added to the historical input database 106. For example, the inputs from the dynamic input database 112 can be added to the historical input database 106 when new initial location prediction models are generated. The input from the dynamic input database 112 can be provided to the trigger module 110, and the data can be used to detect triggers. The input from the dynamic input database 112 can be used to generate the updated location prediction model(s) 108.

### D. Example Triggers for Location Predictions

The electronic device 102 can generate updated location prediction model(s) 108 after the trigger module 110 detects a trigger. The trigger module 110 can detect a trigger when the electronic device 102 detects information that is likely to change an initial location prediction's probability, and the trigger module 110 can detect periodic and event-driven triggers. This data can be stored in the dynamic input database 112.

The probabilities output by the initial location prediction model(s) 104 can change over time, and the electronic device 102 can use periodic triggers that are detected by trigger module 110 to produce updated location predictions that reflect these changes. For example, the electronic device 102 may be more likely to travel to restaurants at mealtimes and less likely to go to the beach after sunset. The trigger module 110 can detect a periodic trigger that occurs at regular intervals (e.g., every 15 minutes), and the electronic device 102 can use a current time for the trigger that is detected by trigger module 110 to generate updated location prediction model(s) 108.

Events may change the likelihood of the probabilities output by the initial location prediction model(s) 104, and updated location prediction model(s) 108 can be generated in response to event-driven triggers that are detected by trigger module 110. For example, the electronic device 102 may update the initial location prediction model(s) 104 after the trigger module 110 detects that the electronic device 102 has left a location of interest. This data can be provided to the trigger module 110 by the dynamic input database 112. The electronic device 102 can measure its trajectory after leaving the location of interest, and the updated location prediction model(s) 108 may reflect that the device's movement makes certain locations more or less likely.

### II. Update Location Prediction Dynamically

An electronic device can make initial location prediction model(s) by generating a location model during a first part of a prediction cycle, e.g., when the device is inactive and charging. The initial prediction model(s) can be updated during a second part of the prediction cycle by rerunning the model with new inputs, or adjusting the model's weights, after detecting a trigger.

### A. Initial Prediction Architecture

An electronic device may produce initial location prediction model(s) for a future time period by generating one or more location models using data from a historical time period. The device's past movement may be predictive of its future behavior and the data may include a record of the electronic device's visit history and known locations during the historical time period. The electronic device may have scheduling information for the future time period, and the data can include calendar information and scheduled travel for the future time period.

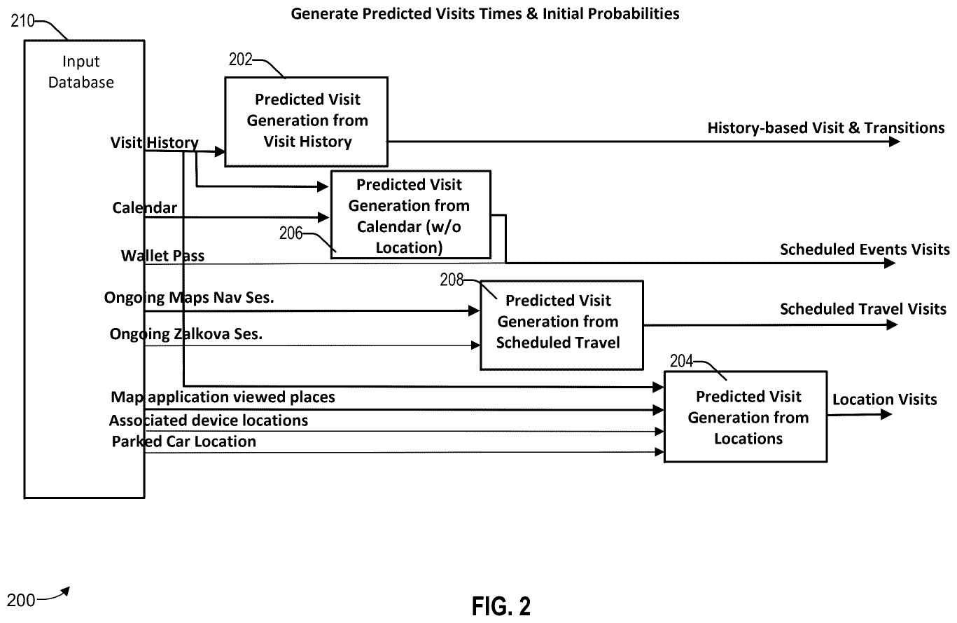

FIG. 2 is a simplified diagram of an architecture 200 for generating initial location predictions, according to various embodiments. The architecture 200 can be used to generate location prediction model(s) that includes any number of a visit history model 202, a location model 204, a calendar model 206, and a scheduled travel model 208. The location prediction model can include separate models for any combination of any number of the of the visit history model 202, the location model 204, the calendar model 206, and the scheduled travel model 208. In some embodiments, the location prediction model can use a fewer number of models to perform any of the functionality of models 202-208. The models 202-208 that are included in the location prediction model can be implemented as machine learning models, statistical models, or a combination of machine learning models and statistical models. The training data for the models 202-208 may be stored in an input database @910. The input database may be stored in local data on the electronic device that is generating the models.

The models depicted in architecture 200 can predict whether an electronic device will visit a location. A visit can include an entry and an exit, and the model may output multiple probabilities for each visit. An entry can be a time when the electronic device arrives at a location and an exit can be a time when the electronic device leaves the location. The prediction time period (e.g., the next 24 hours) can be subdivided into time periods (e.g., 15 minute intervals) and the model can generate a probability that the electronic device enters or exits each identified location. The models can predict a visit if the probability of an entry is above a threshold (e.g., the probability is above 0.8).

### 1. Visit History Model

The architecture 200 from FIG. 2 can include a visit history model 202. A device implementing architecture 200 can use a record of the device's movement and visits over a historical time period. Generating a model may require a large amount of data and the length of the historical time period may be chosen so that there is sufficient data to generate a visit history model. For example, the historical time period can be 1-12 weeks, such as eight weeks in some embodiments.

Generating the visit history model can include training a model to predict future visits based on past visits during the historical time period. The visit history can include a record of locations that were visited during the historical time period. A visited location can be any location where the electronic device has remained for a sufficient amount of time. It may be necessary to distinguish visits from travel through or near a location, and a visited location can be recorded in the visit history as map coordinates that are associated with an entry to the location and an exit from the location. The map coordinates can be one or more sets of coordinates, and the map coordinates may be a geographic bounding box that defines an area of the map. The entry can be a date and time when an electronic device arrives at the visited location and the exit can be a date and time when the electronic device leaves the visited location.

An entry to a visited location can be detected using location data such as coordinates from a global navigation satellite system (GNSS). For example, an entry can be identified if the GNSS data shows that the electronic device has persisted in an area for a threshold amount of time. The data may show that the electronic device has remined in an area for a threshold amount of time by detecting a sufficient number of sequential GNSS position determinations that are clustered in the same area (e.g., within a distance threshold of each other). GNSS data may be used to detect exits from a location. For example, an increase in the distance between sequential GNSS position determinations may indicate that the device has exited the current location.

The location data can include inertial data, and an entry can be detected in response to a change in the inertial data. Inertial data can be used to generate motion classifications, and, for example, an entry can be detected if there is a change from a walking classification to a seated classification for a threshold amount of time. An exit may be detected if there is a change from a walking or seated classification to a bike riding classification. The inertial data can be used to generate a vector showing the direction and speed of the electronic device's movement, and a change to the inertial vector can be used to identify an entry or exit if the change persists for a threshold amount of time. For example, an entry can be detected in response to a decrease in the vector's magnitude (e.g., speed) for fifteen minutes, and an exit can be detected if an increase in the vector's magnitude is detected.

An electronic device that is implementing the architecture 200 can detect an entry or exit based on the device's communication with other devices (e.g., communication data). For example, the device can record an entry when the device connects to a wireless access point, streams media content to a speaker, or controls a video streaming device because these activities are not likely for a device that is traveling between locations. An entry may be detected when the electronic device stops communicating with an electronic device. For example, an entry may be detected when the device ends a Bluetooth connection with a vehicle, and an exit may be detected when the device initiates a Bluetooth connection with the vehicle.

An entry or exit can be detected based on the activity of applications or system processes that are executing on the electronic device (e.g., application data). For example, an entry can be detected if a fitness application is used to record a workout at a particular location. The application data can use information from a wallet application on the electronic device, and a purchase using the wallet may indicate an entry or exit. For example, payment at a restaurant may indicate that the electronic device's user is leaving the location. In some embodiments, an entry can be detected based on the electronic device's charging state (e.g., charging or not charging), and an entry may be detected if the electronic device begins charging at a particular location.

The electronic device can use different combinations of data to detect an entry to a visited location. The visit history can include repeated visits to the same location, and different data types may be used to detect separate entries to a location. For example, location data may be used to detect a first entry to a location, communication data may be used to detect a second entry to the location, and a combination of location data and communication data may be used to detect a third entry or exit.

The electronic device may generate the visit history for the visit history model 202 by monitoring for entries and exits during the device's regular use. The device can record the current time when an entry or exit is detected. The visit history may correspond to a particular geographic area such as a neighborhood, a city, a zip code, a state, or a geofenced area. A geofenced area can be a bounded geographic region, and the geofenced area may be defined by the electronic device's user (e.g., by tracing the bounding box on a map in a graphical user interface).

Separate visit history models may be generated for different geographic areas. For example, an individual who with a home in Houston Texas and a vacation home in Pensacola Florida may have separate visit histories and models for each location. The electronic device may need a sufficiently long visit history for a region in order to generate a visit history model @902. For example, the electronic device may need 8 weeks of data for each region if the historical time period for a visit history is 8 weeks. In some embodiments, a visit history can become stale, and a visit model may only be generated if the visit history data is sufficiently recent (e.g., 8 weeks of visit history data that was generated within the last 3 months). In some embodiments, a visit history model may only be generated for a single region, and the model may only be generated if the model has remained in the region for the length of the historical time period.

### 2. Location Model

The electronic device may use known locations to train a location model 204 to predict location visits. A location may be known from user activity on the electronic device. For example, a location may be known from user searches in a map application. Known locations may be identified from devices that are associated with the electronic device, and a location may be known from smart appliance locations. Locations may be known from vehicle activity, and a known location may be identified from car parking activity.

Locations may be recorded as location information on the electronic device. The location information can be recorded using one or more location protocols. The location protocols can include determining a location using a global navigation satellite system (GNSS), triangulating a location from cell towers, and determining a location from measuring signals from wireless access points.

The location model 204 can be used to predict a probability of a location visit based on viewed locations from a map application. A location can be viewed location if the user interacts with the location in the map application. For example, a location can be a viewed location if the location is selected using the map application's user interface. The viewed location can be selected from search results or by navigating a map in the application's user interface.

Known locations may include the location of associated devices. An electronic device may know the locations of smart appliances (e.g., a smart thermostat), streaming devices, smart speakers, and other associated devices. For example, a user may have a streaming device at his home and a doorbell camera (e.g., a smart appliance) at his Lakehouse. Each of these locations can be known locations that the location model 204 can use to generate location predictions.

The location model 204 may use past parking spaces to generate location predictions. For example, a user may park at the same spot when visiting a particular neighborhood. The user may engage in different activities and visit different locations after parking, but the parking spot can be identified as a known location that the user regularly visits. Parking can be detected based on a device disconnecting from a car's Bluetooth speakers and/or a change in sensor data that indicates that the user has changed movement types (e.g., stopped driving and started walking).

The location model 204 may use a history of visiting a parked car's location to predict that the device will visit a parked car's location even if the car's parking spot changes locations. For example, a user may go to their car at a certain time every day. The car may change locations based on the availability of parking spots, but the user consistently goes to the car's location (e.g., to drive to work). The location model 204 can use the known car parking spot, and the user's history of visiting the car's parking spot, to predict a visit to the parking spot.

### 3. Calendar Model

The calendar model 206 can use scheduled events to predict the probability of a location visit. The entries in the calendar may not identify a location in the calendar data. For example, a calendar entry may say “Daughter's Soccer Game,” but the entry may not identify an address for the game. However, the electronic device may identify a location that is associated with a particular calendar activity based on the past behavior. For example, the electronic device may travel to a specific location at a time that corresponds to the calendar entry.

The calendar model 206 may use a calendar entry to predict an exit without predicting a destination. For example, the device may visit multiple locations in response to the “Daughter's Soccer Game” entry because the soccer team plays home and away games. There may not be sufficient data to train the calendar model 206 to predict a specific destination, but the model may be able to predict an exit from a current location in response to the calendar entry.

A user may have multiple calendars, and not all calendar data may not be predictive. The electronic device implementing architecture 200 can use past behavior to identify whether a calendar entry is associated with location visits. For example, a calendar entry entitled “Call Mom” may be associated with activity, but not with travel. In some circumstances, a device's user does not use a particular calendar for scheduling and the entries in the calendar may not correspond to the users' activity. Training data for the calendar model 206 can include labels for calendar models that indicate whether the entry is associated with an exit from a current location and/or an entry to a location.

An electronic device may have a digital wallet application that includes tickets for scheduled events. For example, the tickets can include airplane tickets, sports tickets, movie tickets, concert tickets, etc. The tickets may be associated with a location and the calendar model 206 may use the tickets to predict location visits. The training data for the location model 204 may include a label indicating whether the user traveled to a location if it is identified in a ticket or a category of tickets (e.g., movie tickets).

### 4. Scheduled Travel Model

Scheduled travel may be used to predict location visits. A user may be able to schedule future travel using a maps application, and the scheduled future travel may be used by a scheduled travel model 208 to predict a location visit. For example, a user may schedule future travel by identifying a destination and a desired departure or arrival time. The scheduled travel model 208 may use the scheduled travel to predict whether the user will travel to the destination. The training data for the scheduled travel model 208 may include whether the device actually traveled to the destination identified in the scheduled travel. The scheduled travel model 208 may use a current navigation session to predict a location in some embodiments. For example, a current navigation session to a particular location may indicate that the device is likely to visit that location.

### B. Dynamic Updating

The initial location prediction model(s) output from the architecture 200 may be one or more models that are generated when an electronic device is charging. The initial prediction models' accuracy can be improved by dynamically updating the location prediction model(s) based on the device's activity as it is used throughout the day. The updates may occur at regular intervals or in response to an event. For example, the updates can happen every fifteen minutes or when the electronic device leaves a current location.

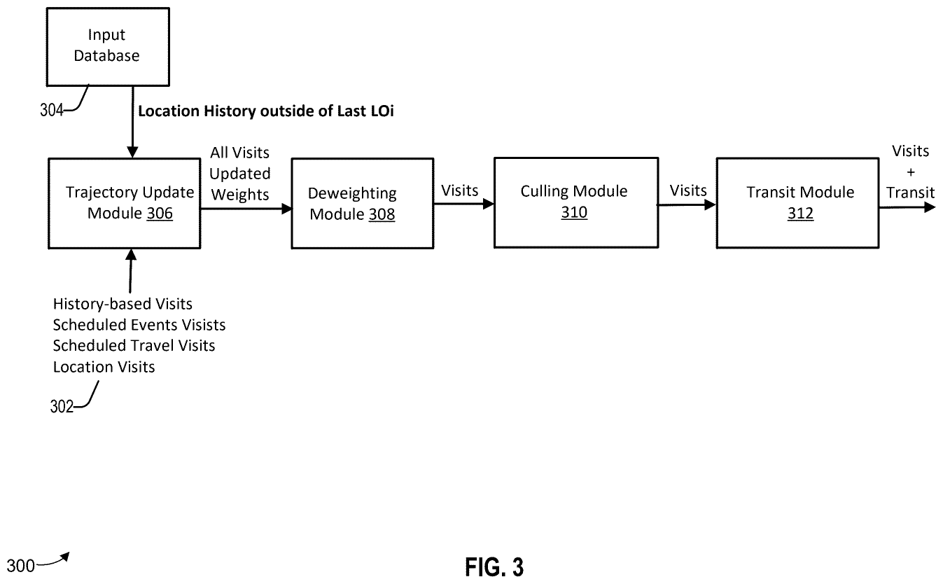

FIG. 3 is a simplified diagram of an architecture 300 for updating initial location prediction model(s), according to various embodiments. The updates can be triggered at regular intervals, and, for example, the initial location prediction models 302 can be generated for fifteen minute windows. The architecture 300 can update the initial predictions at the end of each window. In addition or as an alternative, the architecture 300 can update the prediction model(s) in response to an event. For example, the prediction model(s) may be updated after an electronic device implementing the architecture 300 leaves a location. Updating the prediction model(s) may mean updating the weights in the model using the initial location prediction model(s) 302 and data from the input database 304.

### 1. Trajectory Update Module

The initial location prediction model(s) 302 and updated data from input database 304 can be provided to a trajectory update module 306. The trajectory update module 306 can use the updated data from input database 304 to change the weights of the initial location prediction model(s) 302. For example, the updated data can include a location history for an electronic device that is implementing architecture 300. The location history can include the device's movement after the device left a known location. The trajectory update module 306 can use the movement to generate a trajectory for the device's current movement. For example, sequential GNSS position fixes can be used to plot a trajectory by determining a trend in the position fixes. Inertial data may be used to determine a trajectory in some embodiments.

A trajectory generated by the trajectory update module 306 can be used to change the weights for different initial location prediction model(s) 302. For example, the trajectory update module 306 may increase the model weights for to emphasize predicted location visits that are in the path of the device's trajectory and the module may decrease weights for predicted location visits that are not in the path of the trajectory. The trajectory update module 306 may update the weights for initial location prediction model(s) 302 periodically or in response to an event. For example, the weights may be updated in response to detecting that the electronic device has left a known location. In some circumstances, the trajectory update module 306 may not update the weights unless the electronic device implementing the module has left a known location. For example, the weights may not be updated in response to a time based trigger to update the initial location prediction model(s) 302.

The trajectory update module 306 can adjust the model weights and/or the probability of the potential location visits based on the movement of the electronic device relative to the locations. In some embodiments, the trajectory update module 306 may decrease the probability of a visit to a first location if the electronic device is heading away from the first location, and the trajectory update module 306 may leave the probability of a visit to a second location unchanged if the movement indicates that the electronic device is heading towards the second location. In some embodiments, the trajectory update module 306 may increase the probability of a visit to a first location if the movement indicates that the electronic device is heading towards the first location, and the trajectory update module 306 may leave the probability of a visit to a second location unchanged if the electronic device is heading away from the second location. In some embodiments, the trajectory update module 306 may decrease the probability of a visit to a first location if the electronic device is heading away from the first location, and the trajectory update module 306 may increase the probability of a visit to a second location if the movement indicates that the electronic device is heading towards the second location. The amount of increase or decrease in the probability for each location visit may be the same or different in various embodiments.

The trajectory update module 306 may use a progress-based scale factor to adjust the probability of a projected location visit. The progress-based scale factor can be determined by calculating a projected distance from the user's last visited location to an electronic device's current location along the line from the last visited location to each candidate location. This projected distance can be used to calculate a progress ratio using the following formula:

Progress ratio=projected_distance/total_distance_from_last_location_to_candidate_location

The progress ratio can be mapped to a scale factor. For example, the progress ratio can be mapped to a scale factor and a location's probability can be multiplied by the scale factor. For example, if the progress ratio is between 0.0 and 1.0, the scale factor can be set to 1.0 (e.g., 0.0<=progress ratio<=1.0:scale factor=1.0). The scale factor can be reduced if the progress ratio deviates from the expected ratio for a device heading to the location (e.g., overshoot: progress ratio>1.2; undershoot:progress ratio<−0.2). In such circumstances, the scale factor can be reduced based on the size of the deviation. For example, the scale factor can be reduced from 1.0 down to 0.1 if ratio deviates more than 0.5.

The trajectory update module 306 can use a lateral-based scale factor to adjust a location's probability. The lateral-based scale factor can be determined by calculating the distance from the user's current location to the line connecting the last visited location and a candidate location. The lateral deviation for a location can be the length of a distance between the electronic device's current location and a closest point on a line between the last location and a candidate location. The lateral ratio can be calculated using the following formula:

Lateral ratio=lateral_deviation/total_distance_from_last_location_to_candidate_location

The trajectory update module 306 can map the lateral ratio to a scale factor (e.g., [0.1, 1.0]). The scale factor can be set to 1.0 if the lateral ratio is below a threshold (e.g., lateral ratio<=0.3, scale factor=1.0). However, the scale factor can be gradually reduced if the lateral ratio is above a threshold. For example, the trajectory update module 306 can gradually reduce the scale factor from 1.0 down to 0.1 (e.g., if the lateral ratio deviates more than 0.6).

The trajectory update module 306 can combine the progress-based scale factor and the lateral-based scale factor to generate a scale factor move trend. The ratios can be combined using the following formula:

scale_factor_move_trend=scale_factor_progress*scale_factor_lateral

The trajectory update module 306 can adjust the scale factor move trend based on predicted entry time of a candidate location visit. For example, the scale factor move trend may be unchanged if the predicted entry time at the location is less than 1 hour away. The scale factor move trend can be gradually adjusted towards a neutral value (e.g., 1.0) if the predicted entry time is between 1 hour and 1 hour and 15 minutes in the future. The scale factor can be set to a neutral value (e.g., 1.0) if the predicted entry time exceeds 1 hour 15 minutes.

The trajectory update module 306 may use travel feasibility constraints to adjust probabilities. The travel feasibility constraints can allow the trajectory update module 306 to account for physical constraints (e.g., a maximum possible speed) so that improbable visits do not retain high probabilities. The trajectory update module 306 can determine the travel feasibility constraints by calculating a distance from the user's current location to each candidate location. The trajectory update module 306 can calculate time until a candidate location's predicted entry time, and the module then derive the required speed using the time (e.g., speed=distance/predicted time to entry). The candidate update module 306 can check the calculated speed against a feasible speed. The feasible speed can be one or more speed limits that can be obtained from maps data. The candidate update module 306 may assume a feasible plane speed (e.g., 800-925 km/h) if the distance is greater than a threshold (e.g., 500 km). The probability for a location may not be scaled if the required speed is less than the maximum speed (e.g., scale factor=1.0). The probability may be scaled as the required speed exceeds the maximum speed. For example, the trajectory update module can linearly reduce the scale factor from 1.0 down to 0.1 as the required speed approaches double the maximum speed.

### 2. Deweighting Module

The deweighting module 308 can use device activity to change the weights for initial location prediction model(s) 302 or the output of the trajectory update module 306. For example, the deweighting module 308 may update the initial location prediction model(s) 302 if the electronic device has not left a known location at the time of update, and the output of the trajectory update module 306 may be updated if the device has left a known location.

The deweighting module 308 may change the weights for the predicted visits based on device activity. For example, the device may begin a navigation session to a destination and it is likely that the electronic device will travel to the destination. The deweighting module 308 may reduce the weights (e.g., deweight) for predicted locations that are not the destination because the destination is likely to be the next location visit. Other triggers for deweighting can include receiving any information for a location has a probability that decrease, such as receiving information about trajectory, time, environmental conditions, and the like.

### 3. Culling Module

The trajectory update module 306 and the deweighting module 308 may change the likelihood of the initial location prediction model(s) 302. Some of the updated predictions may have a low probability, but these low probability location visit predictions may influence other location visit predictions. The culling module 310 may remove these low probability location visit predictions by removing (e.g., culling) location visit predictions with a probability that is below a probability threshold. The probability threshold can be any of the following probabilities: 0.001, 0.01, 0.05, 0.10, 0.15, 0.20, 0.25, 0.30, 0.35, 0.40, 0.45, 0.50, 0.55, 0.60, 0.65, 0.70, 0.75, 0.80, 0.85, 0.90, and 0.95.

### 4. Transit Prediction Module

The transit module 312 can use transit information to update the output of the culling module 310. For example, the transit module 312 may change the weights of the location visit probabilities based on how long it would take to reach the location. The transit module 312 may use navigation information from a map program to determine the transit time to a location, and the transit time can be used to determine if is possible to reach a location at the predicted time. For example, the transit module 312 may reduce the weights for a particular location visit that is predicted for one hour from the current time if it would take two hours to reach the location. The transit module 312 may use the transit time between predicted location visits to update the visit probabilities. For example, a visit to a first location from 1:00 pm to 2:00 pm and a second location from 2:30 pm to 5:00 pm may have the highest probabilities for their respective time slots. However, the transit module 312 may reduce the weight of the second location if the transit time between the locations exceeds 30 minutes.

### C. Flow Chart

A mobile device can use past behavior to predict the device's future location. The device can use visited locations from a historical time period to generate a location model. The model may be generated nightly and the model can be updated, and used to predict locations, during the day.

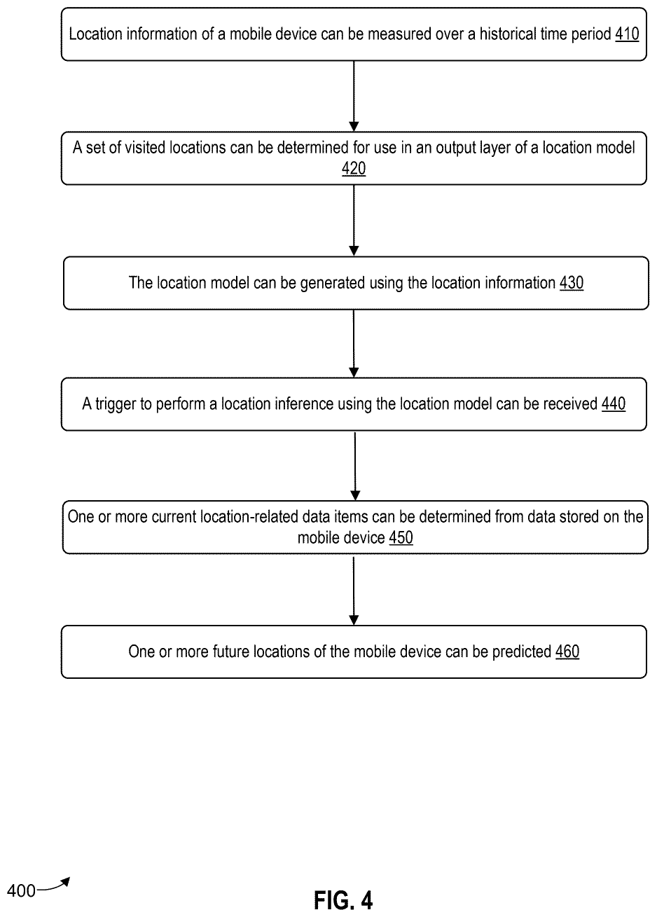

FIG. 4 is a flowchart illustrating a method 400 for predicting future locations, according to various embodiments. In some implementations, one or more method blocks of FIG. 4 may be performed by a mobile device (e.g., electronic device 1400). In some implementations, one or more method blocks of FIG. 4 may be performed by another device or a group of devices separate from or including the mobile device. Additionally, or alternatively, one or more method blocks of FIG. 4 may be performed by one or more components of the mobile device, such as processor 1318, computer-readable medium 1302, Input/Output (I/O) subsystem 1306, wireless circuitry 1308, etc.

At block 410, location information of a mobile device can be measured over a historical time period. The historical time period can be 1 week, 2 weeks, 3 weeks, 4 weeks, 5 weeks, 6 weeks, 7 weeks, 8 weeks, 9 weeks, 10 weeks, 11 weeks, and 12 weeks. The mobile device may need to persist in an area for the duration of the historical time period in order to measure the location information. Persisting in an area can mean remaining in an area for the entire historical time period, or persisting in an area can mean remaining in the area for a percentage of the historical time period. The percentage can be 10%, 20%, 30%, 40 %, 50%, 60%, 70%, 80%, 90%, and 100%.

The location information can be measured using one or more location protocols. The location protocols can include determining a location using a global navigation satellite system (GNSS), triangulating a location from cell towers, and determining a location from measuring signals from wireless access points.

At block 420, a set of visited locations can be determined for use in an output layer of a location model. The location model (e.g., the location prediction model) can be any combination of any number of the visit history model 202, the location model 204, the calendar model 206, and the travel model 208. The set of visited locations can be determined using the location information. The set of visited locations can comprise one or more specific locations, one or more location categories, or one or more specific locations and one or more location categories. The one or more location categories can include a first location category.

At block 430, the location model can be generated using the location information. Generating the location model can include training one or more machine learning models to perform the operations of the location model. In some embodiments, the location model is a statistical model and generating the model can include gathering statistics for the statistical model. The location model can be a first location model of a plurality of location models. One or more other location models of the plurality of location models can be used to predict one or more other future locations of the mobile device over one or more future time intervals. The one or more future locations and the one or more other future locations can be combined to determine one or more final future locations. The one or more other location models can use the one or more current location-related data items to predict the one or more other future locations. The location model may be generated when the mobile device's activity is reduced. For example, the location model may be generated while the device is charging. The location model may be generated while the mobile device is charging overnight and the model generation may be triggered by detecting that the mobile device has charged for a threshold amount of time.

At block 440, a trigger to perform a location inference using the location model can be received. The trigger can be a time-based trigger or an event-driven trigger. A time-based trigger can be received when the mobile device's clock indicates that a specified time has occurred. An event-driven trigger can be received when the electronic device leaves known location, changes a movement type, begins to navigate to a location using a map application, and changes a charging state. An event-driven trigger can be caused by a change in the data on the mobile device. For example a change in the one or more location-related data items can be a trigger. Triggers are described in greater detail at section IV and this description can apply to the triggers described with reference to method 400.

At block 450, one or more current location-related data items can be determined from data stored on the mobile device. The location-related data items can include motion classifications, calendar events, and global navigation satellite system (GNSS) position determinations. Motion classifications can include a transit state such as stationary, walking, running, biking, driving, and riding in public transportation. In some embodiments, a motion classification includes a direction of movement and a rate of movement.

At block 460, one or more future locations of the mobile device can be predicted. The one or more future locations can be over one or more future time intervals. The one or more future locations can be predicted using location models, the one or more current location-related data items, and a current time. Predicting the one or more future locations can include determining a first specific location for the first location category based on the one or more current location-related data items. A notification may be provided based on the one or more future locations. The future locations can be a predicted location visit. The future time intervals can be 1 minute intervals, 2 minute intervals, 3 minute intervals, 4 minute intervals, 5 minute intervals, 10 minute intervals, 15 minute intervals, 20 minute intervals, 30 minute intervals, 45 minute intervals, 1 hour intervals, 2 hour intervals, 3 hour intervals, 4 hour intervals, and 6 hour intervals. The future time intervals can cover a 24 hour period. Notifications are described in greater detail at section VI and this description can apply to the notifications described with reference to method 400.

Predicting the one or more future locations of the mobile device can include determining a current location of the mobile device. The current location can be used to determine a difference between the current location and the one or more future locations. The difference can be used to predict the one or more future locations over the one or more future time intervals.

Predicting the one or more future locations of the mobile device can include determining a motion trajectory of the mobile device. The motion trajectory can be used to predict the one or future locations over the one or more future time intervals.

The mobile device may provide a notification in response to a predicted location. The notification can be provided to one or more applications or system processes on the mobile device, and the notifications may be provided via an application programming interface (API). A navigation session can be initiated in response to a notification. For example, the notification can be provided to a map application that can determine traffic information about a route to a predicted location. The map application may initiate a navigation session to provide turn by turn instructions from the mobile device's current location to a predicted location. The notification can be provided to an electronic device that is associated with the mobile device. For example, the notification can be provided to smart appliances that can take preparatory actions in anticipation of the mobile device's arrival at the predicted location. The smart appliances can include internet connected thermometers/thermostats, lights, locks, garage door openers, and cameras. The preparatory actions can include instructing the thermometer to change the temperature of a structure, instructing the lights to turn on or off, instructing the locks to lock or unlock, and instructing the garage door opener to open or close the garage door. In an example where the electronic device is a thermostat, a preparatory action can comprise controlling a heating element or a cooling element (e.g., such as furnaces, air conditioners, heat pumps, etc.) to cause a temperature change.

Method 400 may include additional implementations, such as any single implementation or any combination of implementations described with reference to method 400 and/or in connection with one or more other processes described elsewhere herein.

Although FIG. 4 shows example blocks of method 400, in some implementations, method 400 may include additional blocks, fewer blocks, different blocks, or differently arranged blocks than those depicted in FIG. 4. Additionally, or alternatively, two or more of the blocks of method 400 may be performed in parallel.

### III. Use of Disparate Models

Future location prediction can be determined using multiple models. The models can use different types of input to generate the predictions and multiple types of models may be used. The output of the models may be combined to produce the location predictions.

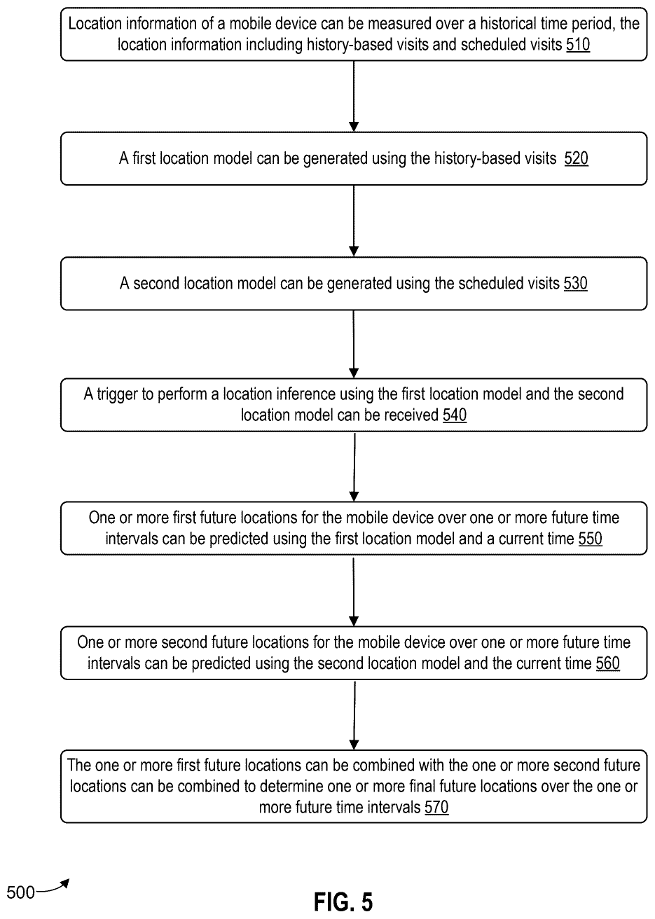

FIG. 5 is a flowchart illustrating a method 500 for predicting future locations using historical and scheduled location information, according to various embodiments. In some implementations, one or more method blocks of FIG. 5 may be performed by a mobile device (e.g., electronic device 1400). In some implementations, one or more method blocks of FIG. 5 may be performed by another device or a group of devices separate from or including the mobile device. Additionally, or alternatively, one or more method blocks of FIG. 5 may be performed by one or more components of the mobile device, such as processor 1318, computer-readable medium 1302, Input/Output (I/O) subsystem 1306, wireless circuitry 1308, etc. In some implementations, any of the models described with reference to method 500 can be implemented using any combination of any number of the visit history model 202, the location model 204, the calendar model 206, and the travel model 208. The description of these models and their updates in sections II.A and II.B can apply to method 500.

At block 510, location information of a mobile device can be measured over a historical time period. The historical time period can be 1 week, 2 weeks, 3 weeks, 4 weeks, 5 weeks, 6 weeks, 7 weeks, 8 weeks, 9 weeks, 10 weeks, 11 weeks, and 12 weeks. The mobile device may need to persist in an area for the duration of the historical time period in order to measure the location information. Persisting in an area can mean remaining in an area for the entire historical time period, or persisting in an area can mean remaining in the area for a percentage of the historical time period. The percentage can be 10%, 20%, 30%, 40 %, 50%, 60%, 70%, 80%, 90%, and 100%.

At block 520, a first location model can be generated using the history-based visits. The first location model (e.g., the location prediction model) can be any combination of any number of the visit history model 202, the location model 204, the calendar model 206, and the travel model 208. Generating the first location model can include training one or more machine learning models to perform the operations of the first location model. In some embodiments, the first location model is a statistical model and generating the model can include gathering statistics for the statistical model. The first location model may be generated when the mobile device's activity is reduced. For example, the first location model may be generated while the device is charging. The first location model may be generated while the mobile device is charging overnight and the model generation may be triggered by detecting that the mobile device has charged for a threshold amount of time.

At block 530, a second location model can be generated using the scheduled visits. The second location model (e.g., the location prediction model) can be any combination of any number of the visit history model 202, the location model 204, the calendar model 206, and the travel model 208. Generating the second location model can include training one or more machine learning models to perform the operations of the second location model. In some embodiments, the second location model is a statistical model and generating the model can include gathering statistics for the statistical model. The second location model may be generated when the mobile device's activity is reduced. For example, the second location model may be generated while the device is charging. The model may be generated while the mobile device is charging overnight and the model generation may be triggered by detecting that the mobile device has charged for a threshold amount of time.

At block 540, a trigger to perform a location inference using the first location model and the second location model can be received. The trigger can be an event-based trigger or a time based trigger. A time-based trigger can be received when the mobile device's clock indicates that a specified time has occurred. An event-based trigger can be received when the electronic device leaves known location, changes a movement type, begins to navigate to a location using a map application, and changes a charging state. An event based trigger can be caused by a change in the data on the mobile device. For example a change in the one or more location-related data items can be a trigger. Triggers are described in greater detail at section IV and this description can apply to the triggers described with reference to method 500.

At block 550, one or more first future locations for the mobile device over one or more future time intervals can be predicted using the first location model and a current time. Predicting the one or more first future locations can include determining a first specific location for the first location category based on one or more current location-related data items. A notification may be provided based on the one or more first future locations. The future locations can be a predicted location visit.

At block 560, one or more second future locations for the mobile device over one or more future time intervals can be predicted using the second location model and the current time. Predicting the one or more second future locations can include determining a second specific location for the first location category based on one or more current location-related data items. A notification may be provided based on the one or more second future locations. The future locations can be a predicted location visit.

At block 570, the one or more first future locations can be combined with the one or more second future locations to determine one or more final future locations over the one or more future time intervals. Combining the one or more first future locations and the one or more second future locations can include averaging the probabilities of the future locations. The future time intervals can be 1 minute intervals, 2 minute intervals, 3 minute intervals, 4 minute intervals, 5 minute intervals, 10 minute intervals, 15 minute intervals, 20 minute intervals, 30 minute intervals, 45 minute intervals, 1 hour intervals, 2 hour intervals, 3 hour intervals, 4 hour intervals, and 6 hour intervals. The future time intervals can cover a 24 hour period.

The mobile device may provide a notification in response to a predicted location. The notification can be provided to one or more applications or system processes on the mobile device, and the notifications may be provided via an application programming interface (API). For example, the notification can be provided to a map application that can determine traffic information about a route to a predicted location. The map application may initiate a navigation session to provide turn by turn instructions from the mobile device's current location to a predicted location. The notification can be provided to an electronic device that is associated with the mobile device. For example, the notification can be provided to smart appliances that can take preparatory actions in anticipation of the mobile device's arrival at the predicted location. The smart appliances can include internet connected thermometers, lights, locks, garage door openers, and cameras. The preparatory actions can include instructing the thermometer to change the temperature of a structure, instructing the lights to turn on or off, instructing the locks to lock or unlock, and instructing the garage door opener to open or close the garage door. Notifications are described in greater detail at section VI and this description can apply to the notifications described with reference to method 500.

Method 500 may include additional implementations, such as any single implementation or any combination of implementations described with reference to method 500 and/or in connection with one or more other processes described elsewhere herein.

Although FIG. 5 shows example blocks of method 500, in some implementations, method 500 may include additional blocks, fewer blocks, different blocks, or differently arranged blocks than those depicted in FIG. 5. Additionally, or alternatively, two or more of the blocks of method 500 may be performed in parallel.

### IV. Event-Driven Triggers

Predictions can be made in response to event based triggers. A mobile device can monitor data including the device's location, whether the device is being used to navigate, and the device's motion. This monitored data can be compared against criteria to detect an event-driven trigger. In some embodiments, the event-driven triggers can include a request from an application. The mobile device may update the model and use the model to predict the device's future location in response to the triggers.

### A. System

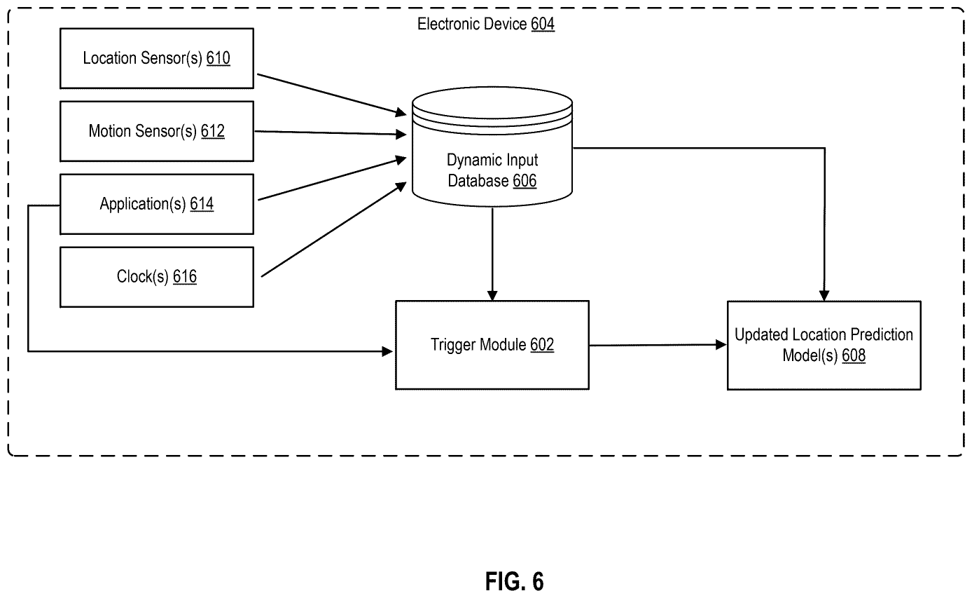

FIG. 6 is a system diagram showing an architecture 600 for event driven triggers according to various embodiments. The trigger module 602 on an electronic device 604 can monitor for event-driven triggers. The triggers can include 1) detecting a new location visit, 2) detecting a change in a motion classification for the electronic device 604, 3) detecting a new navigation session, 4) detecting a request for a location prediction from an application, and 5) detecting a conclusion of an update timer.

The trigger module can detect triggers using data from dynamic input database 606 that is provided to the trigger module 602. The data can be used to generate updated location prediction model(s) 608 in response to a trigger. In some embodiments, a trigger can result in a prediction without updating the model.

The trigger module 602 can use measurements from location sensor(s) 610 to detect that a new location visit. The location sensor(s) can include global navigation satellite system (GNSS) hardware and software that can be used to determine the electronic device's location. The measurements from the location sensor(s) can be used to determine a GNSS position fix and a change to the GNSS position fix may indicate that the electronic device 610 has entered or exited a location. The trigger module 602 may trigger generating updated location prediction model(s) 608 in response to the detected trigger and the model(s) can generate new location predictions in response to the trigger. In some embodiments, the trigger module 602 may cause a new location prediction without updating the model(s).

Data from motion sensor(s) 612 may be used to detect event-driven triggers. For example, the motion data may include motion classifications and, in some embodiments, the trigger module 602 may use motion data to generate motion classification. A motion classification may include standing, sitting walking, running, biking, riding in a car, riding on a train, riding on a bus, riding in a plane, and an unknown classification. A change to the motion classification may cause the trigger module 602 to initiate generating updated location prediction model(s) 608 and a location prediction can be made with the updated models in response to the trigger. In some embodiments, the trigger module 602 can generate a new location prediction without updating the model(s).

The trigger module 602 may use data from application(s) 614 to identify event-driven triggers. The application(s) 614 may include a map application and the data from the application(s) 614 may include an indication that the map application is being used for a navigation session. A navigation session can be turn by turn instructions to guide the electronic deice 604 to a location. The trigger module 602 may cause the electronic device 604 to generate updated location prediction model(s) 608 in response to detecting an active navigation session, or the module may trigger a new location prediction without updating the models.

The application(s) 614 may send a request for a location prediction to the trigger module 602. The request may cause the trigger module 602 to detect an event-driven trigger in response to the request. The trigger module 602 can cause generate updated location prediction model(s) in response to the detected trigger, and the model(s) can be used to make new location predictions. In some embodiments, the trigger module can generate location predictions without updating the model(s).

Data from clock(s) 616 can be an event-driven trigger in some embodiments. The trigger module 602 may initiate a timer in response to detecting an event-driven trigger, or in response to detecting a new location prediction. Data from clock(s) 616 can be used to implement the timer, and the trigger module 602 may generate updated location prediction model(s) 608 and new location predictions at a conclusion of the timer. The trigger module 602 can cause the electronic device 604 to generate new location predictions without updating the model(s) in some embodiments.

### B. Method

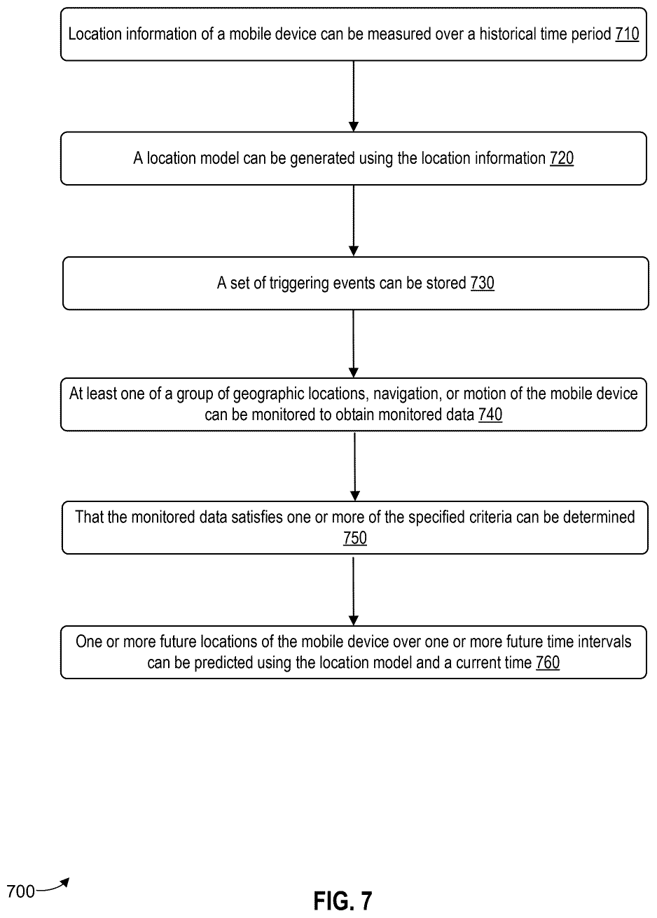

FIG. 7 is a flowchart illustrating a method 700 for predicting future locations using event-driven triggers, according to various embodiments. In some implementations, one or more method blocks of FIG. 7 may be performed by a mobile device (e.g., electronic device 1400). In some implementations, one or more method blocks of FIG. 7 may be performed by another device or a group of devices separate from or including the mobile device. Additionally, or alternatively, one or more method blocks of FIG. 7 may be performed by one or more components of the mobile device, such as processor 1318, computer-readable medium 1302, Input/Output (I/O) subsystem 1306, wireless circuitry 1308, etc. In some implementations, any of the models described with reference to method 700 can be implemented using any combination of any number of the visit history model 202, the location model 204, the calendar model 206, and the travel model 208. The description of these models and their updates in section II.A and II.B can apply to method 700.

At block 710, location information of a mobile device can be measured over a historical time period. The historical time period can be 1 week, 2 weeks, 3 weeks, 4 weeks, 5 weeks, 6 weeks, 7 weeks, 8 weeks, 9 weeks, 10 weeks, 11 weeks, and 12 weeks. The mobile device may need to persist in an area for the duration of the historical time period in order to measure the location information. Persisting in an area can mean remaining in an area for the entire historical time period, or persisting in an area can mean remaining in the area for a percentage of the historical time period. The percentage can be 10%, 20%, 30%, 40 %, 50%, 60%, 70%, 80%, 90%, and 100%.

At block 720, a location model can be generated using the location information. The location model can be any combination of any number of the visit history model 202, the location model 204, the calendar model 206, and the travel model 208. Generating the location model can include training one or more machine learning models to perform the operations of the location model. In some embodiments, the location model is a statistical model and generating the model can include gathering statistics for the statistical model. The location model can be a first location model of a plurality of location models. One or more other location models of the plurality of location models can be used to predict one or more other future locations of the mobile device over one or more future time intervals. The one or more future locations and the one or more other future locations can be combined to determine one or more final future locations. The one or more other location models can use the one or more current location-related data items to predict the one or more other future locations. The model may be generated when the mobile device's activity is reduced. For example, the model may be generated while the device is charging. The model may be generated while the mobile device is charging overnight and the model generation may be triggered by detecting that the mobile device has charged for a threshold amount of time.

At block 730, a set of triggering events can be stored. The triggering events can have specified criteria. The trigger can be a time-based trigger or an event-based trigger. A time-based trigger can be received when the mobile device's clock indicates that a specified time has occurred. An event-based trigger can be received when the electronic device leaves known location, changes a movement type, begins to navigate to a location using a map application, and changes a charging state. An event driven trigger can be caused by a change in the data on the mobile device. For example a change in the monitored data or one or more location-related data items can be a trigger.

At block 740, at least one of a group consisting of geographic locations, navigation, or motion of the electronic device can be monitored to obtain monitored data. The monitored data can be data of the mobile device that is monitored over a time interval, and the time interval can be any portion of a time period between the historical time period and the current time. Navigation of the electronic device can be navigation data from a map application executing on the device. Geographic locations can include an address, map coordinates, and information identifying a wireless network or wireless access point at a location. Motion of the electronic device can be inertial data from the device's accelerometers, magnetometers, and gyroscopes. The motion can include categories of motion such as walking, sitting, running, biking, riding in a car, riding in a bus, riding on a train, and riding on a plane.

At block, 750, that the monitored data satisfies one or more of the specified criteria can be determined. The specified criteria may be satisfied if a difference between the monitored data at the start of the interval and the current monitored data exceeds a threshold. The criteria may be satisfied if the monitored data indicates that the electronic device has reached a particular location.

At block 760, one or more future locations of the mobile device over one or more future time intervals can be predicted using the location model and a current time. The future time intervals can be 1 minute, 2 minutes, 3 minutes, 5 minutes, 10 minutes, 15 minutes, 20 minutes, 30 minutes, 45 minutes, 1 hour, 2 hours, 3 hours, 4 hours, and 6 hours.

The mobile device may provide a notification in response to a predicted location. The notification can be provided to one or more applications or system processes on the mobile device, and the notifications may be provided via an application programming interface (API). For example, the notification can be provided to a map application that can determine traffic information about a route to a predicted location. The map application may initiate a navigation session to provide turn by turn instructions from the mobile device's current location to a predicted location. The notification can be provided to an electronic device that is associated with the mobile device. For example, the notification can be provided to smart appliances that can take preparatory actions in anticipation of the mobile device's arrival at the predicted location. The smart appliances can include internet connected thermometers, lights, locks, garage door openers, and cameras. The preparatory actions can include instructing the thermometer to change the temperature of a structure, instructing the lights to turn on or off, instructing the locks to lock or unlock, and instructing the garage door opener to open or close the garage door. Notifications are described in greater detail at section VI and this description can apply to the notifications described with reference to method 700.

Method 700 may include additional implementations, such as any single implementation or any combination of implementations described with reference to method 700 and/or in connection with one or more other processes described elsewhere herein.

Although FIG. 7 shows example blocks of method 700, in some implementations, method 700 may include additional blocks, fewer blocks, different blocks, or differently arranged blocks than those depicted in FIG. 7. Additionally, or alternatively, two or more of the blocks of method 700 may be performed in parallel.

### V. Location Model Specific to Geographic Bounding Box

A location prediction model may be specific to a geographical area, and this area can be defined by a geographic bounding box. The model may be used for predictions within the geographic area, and the model may be trained on data that is generated within the area. A mobile device executing the location model may freeze the model's weights if the device leaves the geographic area so that the model does not train on new data. However, the model may be used to make predictions outside of the geographic area without training or updates.

### A. Predictions and Visit History Within and Outside Geographical Regions

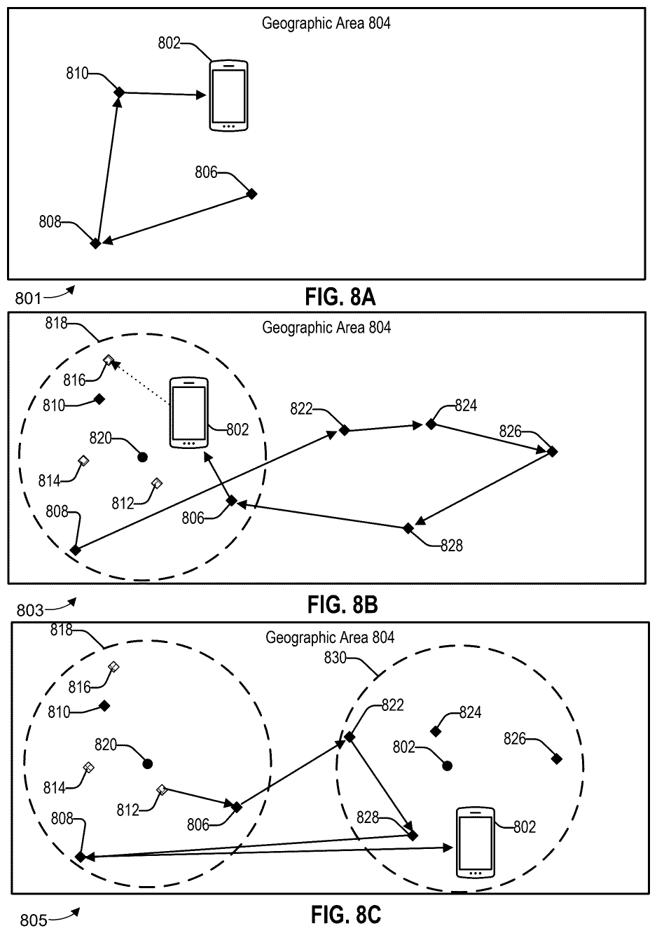

FIGS. 8A-8C are simplified diagrams 801, 803, and 805 showing geographically bound location prediction models according to various embodiments. In FIG. 8A, a mobile device 802 may collect location information as the device moves within a geographic area 804 during a historical time period. The location information can include locations that were visited by the mobile device 802, and the locations include location 806, location 808 and location 810.

The mobile device 802 may record the location information in order to generate a machine learning model to predict the device's future location. The model may not be generated until a sufficient amount of location information has been recorded at the end of the historical time period. Accordingly, the mobile device 802 in FIG. 8A may be recording location information without making future location predictions.

Turning now to FIG. 8B, the mobile device 802 may generate a location prediction model at the conclusion of the historical time period. The mobile device 802 may have sufficient location information to make a model that accurately predicts the device's future location at the conclusion of the historical time period. The model's prediction may be a probability that the mobile device 802 is at each of a group of known locations. The mobile device 802 may have visited the known locations (e.g., location 806, location 808, and 810) or the known locations may be identified from the device's activity during the historical time period. For example, the mobile device 802 may have searched for location 812 using a map application, location 814 may be identified in a ticket in the device's digital wallet, and mobile device 802 may be using the map application to navigate to location 816.

The model may output a probability that the mobile device will be located at each of the known locations across different time periods. The predicted location for a time period can be the known location with the highest probability for that time period. In some embodiments, the model may predict a probability that the mobile device is at an unknown location in addition to the known location probabilities.

The model's predictive accuracy may decrease with increasing distance from the known locations. For example, location 810 may have the highest probability among the known locations, but location 810 may not be a realistic destination if the mobile device is 1000 miles away. Therefore, the model may make unrealistic predictions, or repeatedly predict that the mobile device 802 will be at an unknown location, if the device is too far from where the model's training data was collected.

The model's accuracy can be improved with a geographical region 818. The model can be associated with geographical region 818, and the mobile device 802 can use the model to predict locations while the mobile device 802 is within the geographic bounding box 818. A geographical region can be any volume of geographic area 804 and a geographical region can have any shape. For example, the geographical region can be a geofence which may be circular or a geographical bounding box. A geographical bounding box can be any shape such as a rectangle, triangle, square, or any other polygon.

The dimensions of geographical region 818 may be determined using the location information from the historical time period. The coordinates of each location in the location information, or the known locations, can be averaged to determine a centroid 820. The geographic bounding box 818 can be a circle with a radius extending from the centroid 820, and the dimensions of the geographical region can be determined when the model is generated.

The mobile device 802 may use the model to predict the device's future location within the geographical region 818. The mobile device 802 may use the model to make these predictions while the mobile device is located within the geographical region. The mobile device 802 can stop using the model for location prediction when the device leaves the geographic bounding box 818. For example, the mobile device 802 may travel to location 822, and the model may make no predictions when the device is at location 822.

The mobile device 802 may pause collecting location information when the mobile device is outside of the geographic bounding box 818. For example, the mobile device 802 may visit location 822, location 824, location 826, and location 828 on a weekend vacation. The mobile device 802 may not add locations 822-828 to the location data that is used to generate the model that is associated with geographic bounding box 818. In some embodiments, location data from outside of geographic bounding box 818 may be discarded.

In some embodiments, the mobile device 802 may store location information from outside the geographic bounding box 818. The location information may be stored but, in some embodiments, the mobile device 802 may not use the information to train the model that is associated with the bounding box. However, the mobile device 802 may use location information from outside of the geographical region 818 to train a second model for location predictions. For example, the location information may be used to train a second model if the mobile device 802 has visited locations 822-828 over a historical time period. In some embodiments, the mobile device 802 may only train one model at a time, and the device may train a model for an area if the model has persisted in the area for a historical time period.

FIG. 8C shows geographic area 804 with two geographical regiones. Mobile device 802 may travel regularly between the two areas represented by the geographical regiones and there may be sufficient data to train two models. For example, the mobile device 802 may visit both areas daily because the device's user lives in geographical region 818 and works in geographical region 830. The mobile device 802 may use a first model to make predictions within geographical region 818 and a second model can be used to make predictions when the mobile device 802 is within geographical region 830.

Mobile device 802 may collect two separate sets of location information. The first set of location information can be measured when the mobile device is within the geographical region 818 and the information can be used to train the first model. The second set of location information can be measured when the mobile device 802 is within geographical region 830, and the information can be sued to train the second model. The geographical region 830 can be a radius around a centroid 832 that is determined from the coordinates of the second location information.

### B. Method

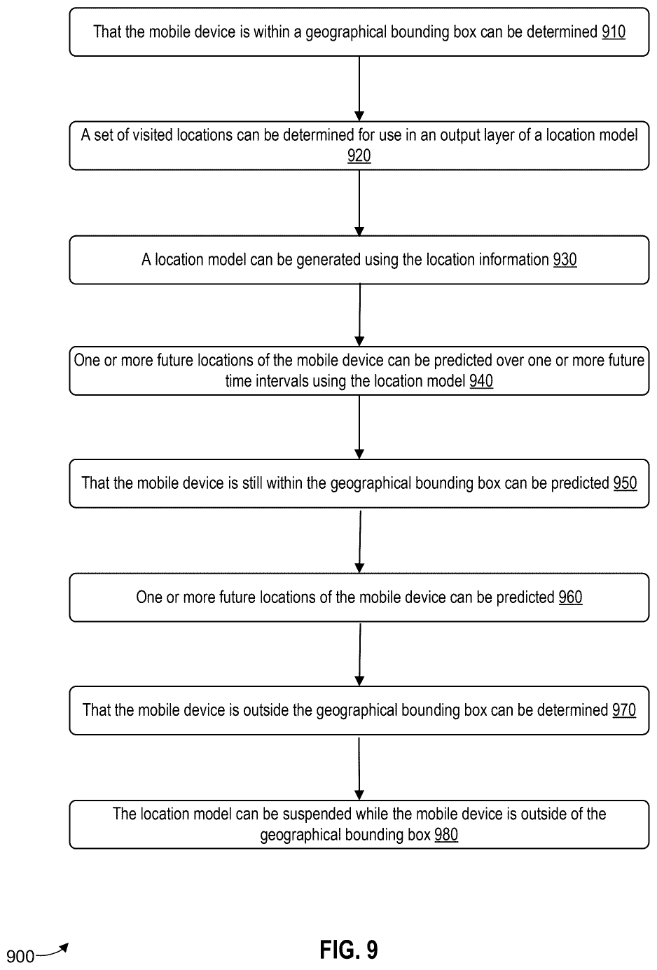

FIG. 9 is a flowchart illustrating a method 900 for predicting locations using a geographic specific location model, according to various embodiments. In some implementations, one or more method blocks of FIG. 9 may be performed by a mobile device (e.g., electronic device 1400). In some implementations, one or more method blocks of FIG. 9 may be performed by another device or a group of devices separate from or including the mobile device. Additionally, or alternatively, one or more method blocks of FIG. 9 may be performed by one or more components of the mobile device, such as processor 1318, computer-readable medium 1302, Input/Output (I/O) subsystem 1306, wireless circuitry 1308, etc. In some implementations, any of the models described with reference to method 900 can be implemented using any combination of any number of the visit history model 202, the location model 204, the calendar model 206, and the travel model 208. The description of these models and their updates in section II.A and II.B can apply to method 900.

At block 910, that the mobile device is within a geographical region can be determined. The geographical region can be a range of map coordinates that define a geographic area. The map coordinates can be coordinates determined by a global navigation satellite system (GNSS). The geographic bounding box can be 1 square kilometer, 2 square kilometers (km 2), 3 km², 4 km², 5 km², 6 km², 7 km², 8 km², 9 km², 10 km², 15 km², 20 km², 25 km², 50 km², 100 km², 200 km², 300 km², 400 km², 500 km², 1000 km², 1500 km², 2000, km², and 50000 km². The geographical region can be circle with a radius from a centroid of the location information that was measured over a historical time period. The radius of the geographical region can be 0.5 kilometers (km), 1 km, 2 km, 3 km, 4 km, 5 km, 10 km, 15 km, 20 km, 25 km, 30 km, 40 km 50 km 100 km 150 km, 200 km, 250 km, 500 km, and 1000 km.

At block 920, location information of the mobile device can be measured over a first historical time period. The location information can be measured using one or more location protocols. The location protocols can include determining a location using a global navigation satellite system (GNSS), triangulating a location from cell towers, and determining a location from measuring signals from wireless access points. Location protocols are described in greater detail in section II. The first historical time period can be 1 week, 2 weeks, 3 weeks, 4 weeks, 5 weeks, 6 weeks, 7 weeks, 8 weeks, 9 weeks, 10 weeks, 11 weeks, and 12 weeks. The mobile device may need to persist in an area for the duration of the first historical time period in order to measure the location information. Persisting in an area can mean remaining in an area for the entire first historical time period, or persisting in an area can mean remaining in the area for a percentage of the first historical time period. The percentage can be 10%, 20%, 30%, 40 %, 50%, 60%, 70%, 80%, 90%, and 100%.

At block 930, a location model can be generated using the location information. The location model can be any combination of any number of the visit history model 202, the location model 204, the calendar model 206, and the travel model 208. Generating the location model can include training one or more machine learning models to perform the operations of the location model. In some embodiments, the location model is a statistical model and generating the model can include gathering statistics for the statistical model. The location model can be a first location model of a plurality of location models. One or more other location models of the plurality of location models can be used to predict one or more other future locations of the mobile device over one or more future time intervals. The one or more future locations and the one or more other future locations can be combined to determine one or more final future locations. The one or more other location models can use the one or more current location-related data items to predict the one or more other future locations. The model may be generated when the mobile device's activity is reduced. For example, the model may be generated while the device is charging. The model may be generated while the mobile device is charging overnight and the model generation may be triggered by detecting that the mobile device has charged for a threshold amount of time.

At block 940, one or more future locations of the mobile device over one or more future time intervals can be predicted using the location model. The one or more future locations can be within the geographical region or within a threshold distance of the geographical region in various embodiments. The future time intervals can be 1 minute intervals, 2 minute intervals, 3 minute intervals, 4 minute intervals, 5 minute intervals, 10 minute intervals, 15 minute intervals, 20 minute intervals, 30 minute intervals, 45 minute intervals, 1 hour intervals, 2 hour intervals, 3 hour intervals, 4 hour intervals, and 6 hour intervals. The future time intervals can cover a 24 hour period.

At block 950, that the mobile device is still within the geographical region can be predicted. The location predictions may include a probability that the mobile device is at each of one or more location categories. Each location can be a separate category in the location categories and the location categories can include a category for “outside of the geographical region.” The model can predict whether the mobile device is in within the bounding box using the probability for each location category. The mobile device may be within the bounding box if the highest probability is for a location, and the mobile device may be outside of the bounding box if the highest probability is for the “outside of the geographical region” category.

At block 960, the location model can be updated using location information that is measured while the mobile device is within the geographical region. The data that is measured can be current location-related data items. The location-related data items can include motion classifications, calendar events, and global navigation satellite system (GNSS) position determinations. Motion classifications can include a transit state such as stationary, walking, running, biking, driving, and riding in public transportation. In some embodiments, a motion classification includes a direction of movement and a rate of movement. The location model may be updated in response to a trigger. Triggers are described in greater detail at section IV and this description can apply to the triggers described with reference to method 900.

At block 970, that the mobile device is outside of the geographical region can be determined. The mobile device may use location data from a global navigation satellite system (GNSS) to determine that the mobile device is outside of the bounding box.

At block 980, the location model can be suspended while the mobile device is outside the geographical region. The mobile device may not make location predictions while the location model is suspended. In some embodiments, the location model may be used for predictions outside of the geographical region, and the location model's weights may be frozen so that the model is not trained on data from outside of the geographical region.

The mobile device may provide a notification in response to a predicted location. The notification can be provided to one or more applications or system processes on the mobile device, and the notifications may be provided via an application programming interface (API). For example, the notification can be provided to a map application that can determine traffic information about a route to a predicted location. The map application may initiate a navigation session to provide turn by turn instructions from the mobile device's current location to a predicted location. The notification can be provided to an electronic device that is associated with the mobile device. For example, the notification can be provided to smart appliances that can take preparatory actions in anticipation of the mobile device's arrival at the predicted location. The smart appliances can include internet connected thermometers, lights, locks, garage door openers, and cameras. The preparatory actions can include instructing the thermometer to change the temperature of a structure, instructing the lights to turn on or off, instructing the locks to lock or unlock, and instructing the garage door opener to open or close the garage door. Notifications are described in greater detail at section VI and this description can apply to the notifications described with reference to method 900.

Method 900 may include additional implementations, such as any single implementation or any combination of implementations described with reference to method 900 and/or in connection with one or more other processes described elsewhere herein.

Although FIG. 9 shows example blocks of method 900, in some implementations, method 900 may include additional blocks, fewer blocks, different blocks, or differently arranged blocks than those depicted in FIG. 9. Additionally, or alternatively, two or more of the blocks of method 900 may be performed in parallel.

### VI. Notifications

The predicted locations can be used to take actions in anticipation of a device's arrival at a location. The predicted location model can output notifications if the model predicts a change in a device's location. The notification can be presented to the user on the device's display and the notification can include information about the predicted location or navigation to the predicted location. For example, the notification can show a travel time to the predicted location or traffic information about the route to the location.

The notification can be provided to applications or system processes executing on an electronic device that is implementing the location prediction techniques. For example, the notification can be provided to a map application on a mobile device. The map application can use the notification to automatically initiate a navigation session to the predicted location without user input. For example, the map application may prepare turn by turn instructions to the predicted location in response to the notification, and these instructions can be presented to the user on a display. The notification may be provided to the application or system process using an application programming interface as described in section VIII.

The notification may be provided by an electronic device to associated devices. For example, the location may be predicted by a mobile device and the notification may be provided to a companion device (e.g., a smartwatch) for presentation on the companion device's display. The companion device can be any electronic device that is in communication with the electronic device over a short range communication link (e.g., a Bluetooth connection). The notification may be provided to the companion device using an application programming interface as described in section VIII.

The notification may be provided to associated devices at the predicted location. For example, the location may be a vacation home and the associated devices can include smart appliances such as thermometers and lights that are connected to the internet. The smart appliances may take preparatory actions in response to the notification, and, for example, the lights may turn and the temperature may be changed in anticipation of the device's arrival at the predicted location.

Notifications may be triggered in response to an electronic device's activity. A notification can be a location prediction for the device, and the notification's timing may impact the notifications utility. For example, a notification may proactively trigger a navigation session by a map application to help the device's user to navigate to a predicted location. However, initiating the navigation session too early, or when the device's user is not interacting with the electronic device, may waste battery capacity without providing utility to the user.

The electronic device can trigger notifications in response to predicting that the device is exiting a location. The electronic device can use motion data to detect motion classification changes, and the device may present a notification in response to a motion classification change. Motion classifications can include seated, walking, running, biking, riding in a car, riding on a bus, riding on a train, riding in the subway, and riding in a plane. A change in a motion classification (e. g, seated to walking) may indicate that the electronic device's user is leaving a location.

The electronic device may present notifications based on the device's interactions with other electronic devices. For example, the electronic device may detect that a distance to a Bluetooth enabled car key has decreased and this may indicate that the device's user is preparing to leave a current location. In another example, the electronic device can detect that the electronic device has put on a smartwatch and begun playing music to Bluetooth headphones. The electronic device can use the interactions with other devices to trigger notifications when the device's user is likely to leave a current location.

The electronic device may present notifications when the devices' sensor data indicates that the user is interacting with the electronic device. The notifications can therefore be presented to the user when the notifications are likely to be seen by the user. For example, the notifications may be presented when the device's display is unlocked because of user input to the display. The device may monitor motion to determine whether the user is holding or moving the electronic device and the notification may be presented when the motion data indicates that the user is interacting with the device.

The electronic device may present notifications before a predicted exit from a location. For example, the location model may predict that the electronic device is going to be at a work location at 9:00 am. The electronic device may present a notification at 8:15 am to provide information about the anticipated travel. The timing of this notification may be altered (e.g., advanced or delayed) based on the activity at the electronic device. For example, the notification may be presented at 8:05 am if the electronic device's activity indicates that the device's user is preparing to leave the current location.

### VII. Use Case for Familiar Routes

To aid in navigating the world, many people may use a navigation aid such as a map application on a phone or other device to get between the various locations they utilize in day to day life. The map application may be configured to receive inputs from the user (e.g., an origin and/or a destination) and then determine a route for the user based on factors such as traffic, weather, time of day, user preferences, etc. For example, the user may request a route from their home to a new place of employment. The map application may determine the fastest route in the morning based on traffic patterns, etc. and provide the directions to the user. The user may then follow this route for a time as the route becomes familiar to them. Eventually, the user may cease utilizing the map application for directions between home and work altogether. However, because the user utilized the map application to determine the familiar route, the map application (and/or related services) may retain data indicating the familiar route.

In other cases, however, the user may not utilize the map application to determine an initial route between home and work. The user may instead simply discover a route themselves and utilize this route until it becomes the familiar route. While this may not seem like a hurdle initially, many users still utilize map applications to find routes in abnormal situations like unplanned road closures, emergencies, new destinations, wrong turns, etc. If the user requests a route (during an abnormal situation), the map application may then direct the user along an unfamiliar route. In other words, the map application may make an already unfamiliar journey even less familiar to the user. In an emergency, for example, this unfamiliarity may lead to panic and further complicate the journey for the user. This can lead to safety issues, poor user experience, and other negative effects. Thus, there is a need for a map application to determine a familiar route used by a user and for the map application to determine directions using the familiar route.

One way to address these issues may be to provide inputs for a user to indicate their own familiar (or preferred routes). If, as in the first example above, the user utilizes the map application to generate routes between the origin and the destination, it may be relatively simple to identify a familiar route. The map application may generate a pop-up window (for example), that prompts the user to label the route as a preferred or familiar route. The map application may then store data associated with the familiar route locally and/or at a remote service. In the second example, however, the map application has no data indicating the user's preferred route. The map application may then provide inputs for the user to enter the familiar route (e.g., drawing on a map, turn by turn directions, etc.). However, this may be a cumbersome task for the user, and also require the user's exact knowledge of the route (distances, street names, etc.). Likely, this would be overburdensome for the user and most users would not enter a familiar route into the map application.

A solution may therefore be to determine a familiar route for the user based on location data associated with the user. The map application may be implemented on a mobile device associated with the user. The mobile device may collect location data for services such as emergency calls, cellular communication, location services, and other such services. For example, the mobile device may receive approximate locations from Wi-Fi routers, cell towers, GPS satellites, etc. as the mobile device (i.e., the user) travels between points. Thus, the location data may be used to recreate a route travelled by the user.

The user may take the route (e.g., between home and work), a first day, but on a second data, the user may take a different route. Thus, the location data for a single trip may not be sufficient to determine a familiar route. Instead, the map application may access location data over a period of time to identify patterns in the location data corresponding to geographical locations, times, etc. The map application (and/or related services), may then correlate the location data over time to determine not only places (e.g., home and work), but familiar (sometimes “preferred”) routes between places commonly visited by the user. The familiar route may therefore automatically determine the familiar route without the involvement of the user.

Subsequently, if the user accesses the map application to route to a new location, the map application may determine that the new location is with a certain radius of the familiar route (and/or a familiar location). Then, the map application may generate a route to the new location based on the familiar route, minimizing the time spent off of the familiar route. Similarly, the map application may determine that there is an unexpected closure on the familiar route. The map application may then push a notification to the user (e.g., via a pop-up notification) indicating that the familiar route is not available. The map application may then generate a route that detours the unexpected closure while maximizing the user's time spent on the familiar route. By automatically determining the familiar route, the map application may provide a better user experience by reducing the work done by the user to identify the route. Then, without action from the user, the map application may direct the user along the familiar route in case of an abnormal situation. The advantage provided by the systems and techniques described herein may be to provide accurate, convenient navigation aids to a user while keeping the user on familiar routes.

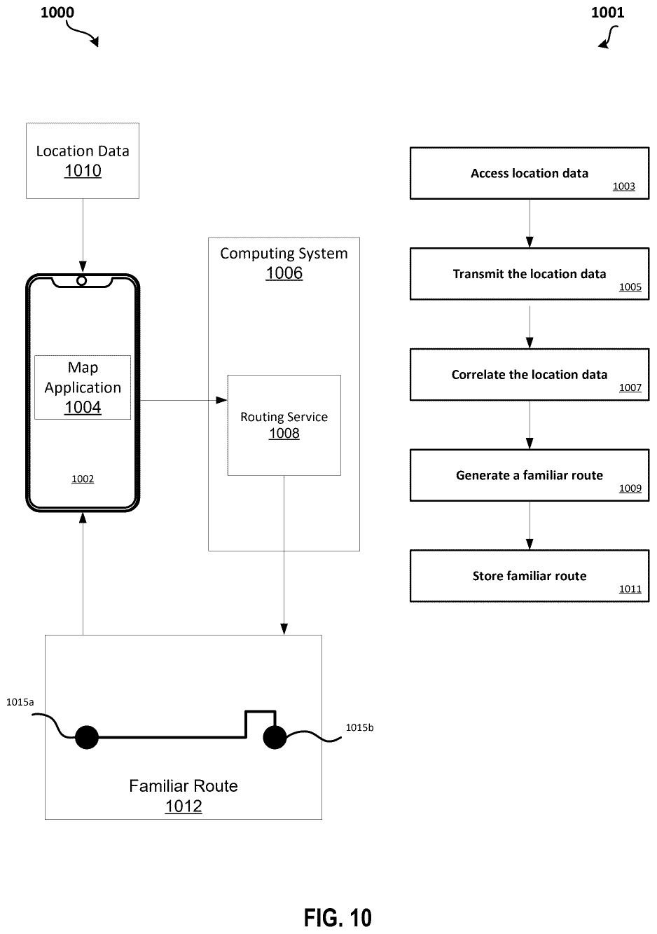

FIG. 10 illustrates a system 1000 and a process 1001 for generating a familiar route 1012 for a user, according to certain embodiments. The system 1000 may include user device 1002 with a map application 1004, a computing system 1006 and hosting a routing service 1008. The user device 1002 may be a cell phone, smartphone, tablet, laptop, computer, wearable device (e.g., a watch, brooch, eyeglasses, etc.), or any other such device. The user device 1002 and the computing system 1006 may be associated with a single entity, such as a manufacturer of the user device 1002. The user device 1002 may therefore include and/or execute one or more components that are enabled to communicate directly with components of the computing system 1006, with or without the involvement of a user. For example, the map application 1004 may communicate data to and from the routing service 1008 as a background process. Thus, the user device 1002, the map application 1004, the computing system 1006, and the routing service 1008 may be considered a single system (at least from a mapping and routing perspective).

The map application 1004 may be configured to access, generate, and/or display maps and/or routing information on a display of the user device 1002. One or more routes may be stored on the user device 1002. The routes may include various points such as start points, end points, points associated with a desired location, and other such information. The map application 1004 may access data from external sources (e.g., the Internet, etc.) and/or internal sources such as location data used by other systems of the user device 1002. For example, the user device 1002 may utilize cell tower triangulation (CTT), global positioning satellite (GPS) data, Wi-Fo positioning techniques, Bluetooth Low Energy (BLE) beacons, device sensors (e.g., gyroscopes, accelerometers, etc.), and/or other types of location data in order to provide various services to a user (e.g., cellular communication, emergency services, etc.). The map application 1004 may then utilize some or all of this data (internal and/or external) to determine locations, routes, etc. for the user.

In order to determine routing data for the user, the map application 1004 may communicate with the routing service 1008 implemented on the computing system 1006. The routing service 1008 and the map application 1004 may communicate via a cellular network, satellite communication, Wi-Fi, etc. as a backend communication in order to update route data, location data, etc. For example, the routing service 1008 may access different sources (e.g., traffic data, weather data, government alerts, etc.) and push relevant data to the user device 1002 via the map application 1004 (and/or some other back end service). The routing service 1008 may also be configured to determine routes based on data transmitted by the map application 1004. For example, the user device 1002 may be communicably connected to the computing system 1006. A user of the user device 1002 may then request routing data (e.g., via a user input). While the map application 1004 may be configured to generate the routing data, the user device 1002 may determine that it is more efficient to generate the routing data at the routing service 1008. Then, the map application 1004 may transmit some or all of the user inputs to the computing system 1006 and/or the routing service 1008, and the routing service 1008 may return the requested routing data.

At 1003, the map application 1004 may access location data 1010. The location data 1010 may be accessed from external sources and/or may be accessed from data on the user device 1002 for some other purpose. The location data 1010 may include location data gathered by the user device 1002 over a given time period. For example, the user device 1002 may be connected to a Wi-Fi router at a first time period at a first location 1015a (e.g., the user's home). The first time (in this example) may begin at midnight-8 am on a first day (i.e., the user is likely at home). The user device 1002 may be assigned an IP address at the first location by the Wi-Fi router. The IP address may include data used to determine an approximate location. Additionally, or alternatively, the user device 1002 may utilize wi-fi positioning to determine location data at the first time. At a second time period (e.g., 8 am-8:45 am), the user may travel along a route 1012 to a second location 1015b. The user device 1002 may then collect location data such as CTT data, GPS data, etc. along various points along the route 1012. At a third time period (e.g., 8:45 am-5 pm), the user device 1002 may be at a second location 1015b. The user device 1002 may then utilize a second IP address etc. to determine the location of the user device 1002 at the second location. Thus, the location data 1010 may include data indicating a plurality of locations throughout multiple time periods.

At 1005, the map application 1004 (or some other component of the user device 1002) may transmit some or all of the location data 1010 to the routing service 1008. Prior to transmitting the location data 1010, a privacy service (not shown) of the user device 1002 may scrub the location data 1010 for identifying information associated with the user. For example, the location data 1010 may include addresses, user account information, metadata associated with communications etc. The privacy module may identify any such sensitive data and remove the sensitive data from the location data 1010. In other words, the map application 10014 may only transmit anonymized location data off device, such that the user of the user device 1002 is anonymous (even to the entity).

Furthermore, the privacy module and/or the map application 1004 may modify some or all of the location data 1010 to make the data less fine. For example, Wi-Fi positioning may include positioning with an accuracy of 1-10 m, inclusive. The privacy module may then randomize some or all of the Wi-Fi positioning data such that the positioning is accurate within 20 m, 50 m, etc. By doing so, the location data transmitted to the routing service 1008 may be accurate enough to determine a general location, but not so accurate as to violate the privacy of the user.

At 1007, the routing service 1007 may correlate some or all of the location data 1010. As described above, the location data 1010 may indicate several locations over several time periods. The routing service 1008 may correlate a time period of repeated location data with a geographical location (e.g., the first and/or second locations 1015a-b). For example, if the location data 1010 includes data indicating a single location for a given time period (e.g., 10 hour, 2, hours, 6 hours, etc.), the routing service 1008 may identify the single location as a familiar geographical location. On the other hand, if the location data 1010 indicates that the user device 1002 is only at a particular location for a short time (e.g., 1 sec, 5 sec, 5 min., etc.), the routing service 1008 may determine that the user device 1002 is moving-on a route. Thus, for the first time period, the location data 1010 may be identical (or substantially so). The routing service 1008 may then determine that the user device 1002 was stationary for the first time period and correlate the location data 1010 collected during the first time period as being the first location 1015a. The routing service 1008 may determine other information about the first location 1015a, such as an address, street block etc. in order to determine routes from the first location to other locations. The routing service 1008 may generate a record of the first location 1015a (e.g., in a datastore, device profile etc.).

The routing service 1008 may then determine the various locations identified in the location data 1010 during the second time period (i.e., those corresponding to the route 1012; sometimes “route data”) and the third time period (i.e., the second location 1015b). The routing service 1008 may correlate the location data 1010 and the time periods to determine that the first location 1015a and the second location 1015b are familiar locations associated with the user device 1002. Then, the portion of the location data 1010 corresponding to the route data may be determined to be the route taken by the user device 1002 between the first and second locations 1015a-b. The system 1000 may repeat steps 1003-1007 over a period of time (e.g., 2 days, 3 days, 2 weeks, etc.). Thus, the system 1000 may collect a large enough sample size to account for daily variations in the user device's 1002 route between the first and second locations 1015a-b.

Then, at 1009, the routing service 1009 may generate the familiar route 1012 as the user device's 1002 familiar route between the first and second locations 1015a-b. The familiar route 1012 (although shown as a map in FIG. 10) may data indicate turn-by-turn directions, landmarks, waypoints, etc. In some embodiments, the step 1003-109 may be repeated in order to generate multiple familiar routes. For example, the user may utilize the familiar route 1012 between the first location 1015a and the second location 1015b at a first time, and take a different route on the return journey. The system 1000 may then generate a familiar route for each journey.

At 1011, the map application 1004, the routing service 1008, and/or some other component of the user device 1002 and/or the computing system 1006 may store the familiar route for subsequent access. The map application 1004 may cause a notification to be displayed indicating that the familiar route 1012 has been generated and stored and prompt the user for confirmation. If the user indicates that the familiar route 1012 is correct, the familiar route 1012 may be stored (e.g., on a secure partition of the user device). If the user indicates that the familiar route is incorrect, the route may be discarded. In some embodiments, the familiar route 1012 may be stored automatically.

Further discussion of the use case for familiar routes can be found in the U.S. Patent Application entitled “ROUTE GUIDANCE FOR FAMILIAR ROUTES” filed on May 19, 2025 (Attorney Docket No.: 090911-1497769-P71843USP1) which is incorporated for all purposes.

### VIII. Machine Learning Techniques

Any of the models in this disclosure can be implemented as machine learning models. For example, the location prediction model can be implemented as a convolutional neural network that is trained on data from a historical time period. The model can be trained overnight, the model's weights can be updated during the day, and the model can be used to predict a device's future location.

### A. Neural Network Implementation for Visit History Model

The location prediction model can be implemented as a machine learning model such as a convolutional neural network. The locations can be treated as categorical variables and the locations that are input into the model can be one hot encoded. In some embodiments, the one hot encoded location variables can include transit states such as walking, biking, in a car, in a bus, on a train, and in an airplane. One hot encoding the locations can mean that each location is treated as a separate binary category in a matrix. The matrix includes a column for each one hot encoded category and a new column can be added for each new location.

A feature vector representing a location visit can include the one hot encoded location and one or more times (e.g., an entry and an exit). The time is a cyclical variable and the date and time can be encoded as cyclical functions such as a sine function and +a cosine function. Time within a day can correspond to a value between 0 and 2π. For example, the time of day can be encoded as two separate values: sin(x) and cos(x) where x is 2π*TimeInHours/24. The day of the week can be encoded as two separate values: sin(y) and cos(y) where y is 2π*WeekdayNumber/7. The WeekdayNumber can be a number between 1 and 7 where each integer represents a day of the week (e.g., 1 represents Monday and 7 represents Sunday). The feature vector for a location visit that is input to the model can include the one hot encoded location and the sine values that correspond to the visit's entry and exit.

The output from the model can identify a predicted location for one or more time periods. For example, the time periods can be 15 minute intervals and the output can be the predicted location for each of these intervals. The predicted location can be obtained by determining the probability for each location in a time interval and selecting the location with the highest probability as the predicted location.

### B. Additional Details

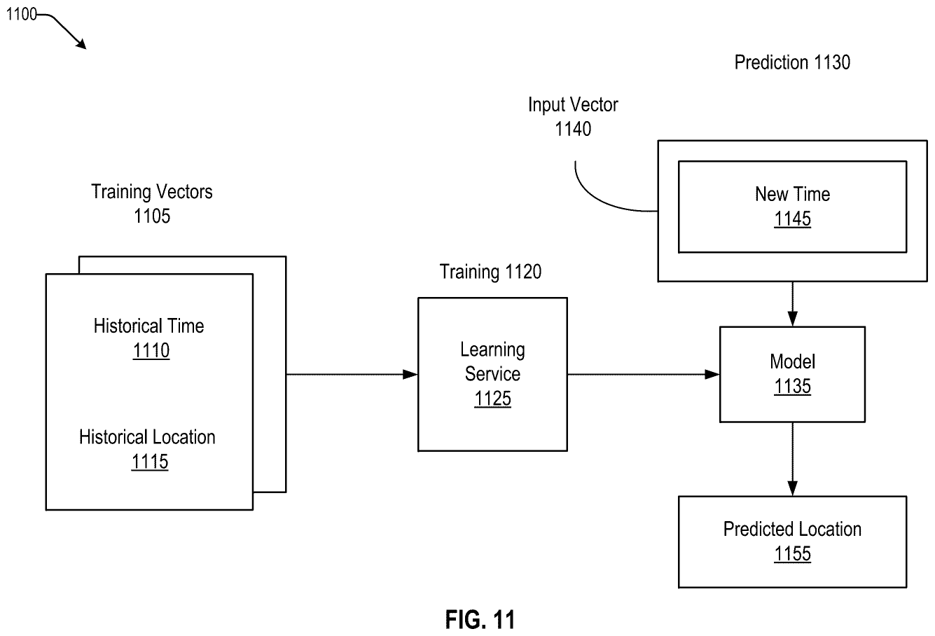

FIG. 11 depicts an architecture for training a machine learning model according to the embodiments of the present disclosure. Training vectors 1105 are shown with historical time 1110 and a historical location 1115. Historical time 1110 can include a time when the mobile device visited the historical location 1115. For ease of illustration, only two training vectors are shown, but the number of training vectors may be much larger, e.g., 1, 10, 100, 1,000, 10,000, 100,000, or more. Training vectors could be made for different physical environments, the same physical environment over different time periods.

Historical time 1110 have property fields that can correspond to the clock time of a target mobile device and the skilled person will appreciate the various ways that such time values can be configured. Historical location 1115 include the location of an electronic device during a time period that corresponds to the time the historical time 1110. The historical location 1115 can be determined by the same device that measured the historical time 1110, or the historical location 1115 and the historical time 1110 can be measured by separate devices.

Training vectors 1105 can be used by a learning service 1125 to perform training 1120. A service, such as learning service 1125, being one or more computing devices configured to execute computer code to perform one or more operations that make up the service. Learning service 1125 can optimize parameters of a model 1135 such that a quality metric (e.g., accuracy of model 1135) is achieved with one or more specified criteria. The accuracy may be measured by comparing historical locations 1115 to predicted locations. Parameters of model 1135 can be iteratively varied to increase accuracy. Determining a quality metric can be implemented for any arbitrary function including the set of all risk, loss, utility, and decision functions.

In some embodiments of training, a gradient may be determined for how varying the parameters affects a cost function, which can provide a measure of how accurate the current state of the machine learning model is. The gradient can be used in conjunction with a learning step (e.g., a measure of how much the parameters of the model should be updated for a given time step of the optimization process). The parameters (which can include weights, matrix transformations, and probability distributions) can thus be optimized to provide an optimal value of the cost function, which can be measured as being above or below a threshold (i.e., exceeds a threshold) or that the cost function does not change significantly for several time steps, as examples. In other embodiments, training can be implemented with methods that do not require a hessian or gradient calculation, such as dynamic programming or evolutionary algorithms.

A prediction stage 1130 can provide a predicted location 1155 for an input vector 1140 based on new time 1145. The predicted location 1155 can be a predicted location of the device at the time represented by input vector 1140. The new time can be of a similar type as historical time 1110. If new time is of a different type, a transformation can be performed on the data to obtain data in a similar format as historical time 1110. Ideally, predicted location 1155 corresponds to the true location for input vector 1140.

A “machine learning model” (ML model) can refer to a software module configured to be run on one or more processors to provide a classification or numerical value of a property of one or more samples. An ML model can be generated using sample data (e.g., training data) to make predictions on test data. One example is an unsupervised learning model. Another example type of model is supervised learning that can be used with embodiments of the present disclosure. Example supervised learning models may include different approaches and algorithms including analytical learning, statistical models, artificial neural network, backpropagation, boosting (meta-algorithm), Bayesian statistics, case-based reasoning, decision tree learning, inductive logic programming, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), random forests, ensembles of classifiers, ordinal classification, data pre-processing, handling imbalanced datasets, statistical relational learning, or Proaftn, a multicriteria classification algorithm. The model may include linear regression, logistic regression, deep recurrent neural network (e.g., long short term memory, LSTM), hidden Markov model (HMM), linear discriminant analysis (LDA), k-means clustering, density-based spatial clustering of applications with noise (DBSCAN), random forest algorithm, support vector machine (SVM), or any model described herein. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

Examples of machine learning models include deep learning models, neural networks (e.g., deep learning neural networks), kernel-based regressions, adaptive basis regression or classification, Bayesian methods, ensemble methods, logistic regression and extensions, Gaussian processes, support vector machines (SVMs), a probabilistic model, and a probabilistic graphical model. Embodiments using neural networks can employ using wide and tensorized deep architectures, convolutional layers, dropout, various neural activations, and regularization steps.

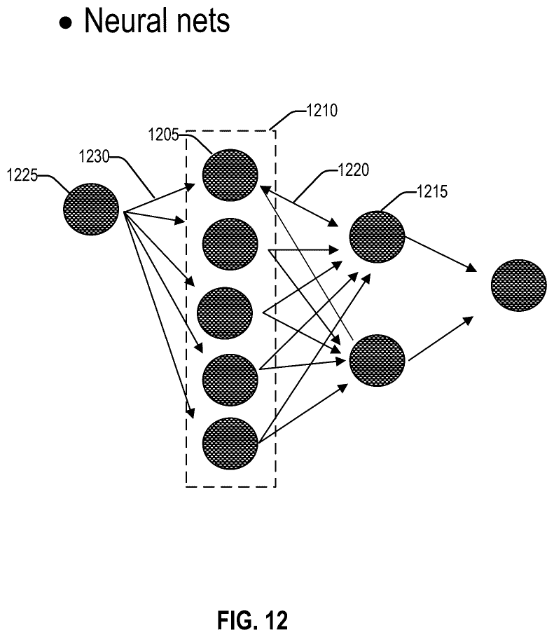

FIG. 12 shows an example machine learning model of a neural network. As an example, model 1235 can be a neural network that comprises a number of neurons (e.g., Adaptive basis functions) organized in layers. For example, neuron 1205 can be part of layer 1210. The neurons can be connected by edges between neurons. For example, neuron 1205 can be connected to neuron 1215 by edge 1220. A neuron can be connected to any number of different neurons in any number of layers. For instance, neuron 1205 can be connected to neuron 1225 by edge 1230 in addition to being connected to neuron 1215.

The training of the neural network can iteratively search for the best configuration of the parameter of the neural network for feature recognition and prediction performance. Various numbers of layers and nodes may be used. A person with skills in the art can easily recognize variations in a neural network design and design of other machine learning models. For example, neural networks can include graph neural networks that are configured to operate on unstructured data. A graph neural network can receive a graph (e.g., nodes connected by edges) as an input to the model and the graph neural network can learn the features of this input through pairwise message passing. In pairwise message passing, nodes exchange information and each node iteratively updates its representation based on the passed information. More detail about graph neural networks can be found in the following reference: Wu, Zonghan, et al. “A comprehensive survey on graph neural networks.” IEEE transactions on neural networks and learning systems 32.1(2020): 8-2 8.

### IX. API Interfaces

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

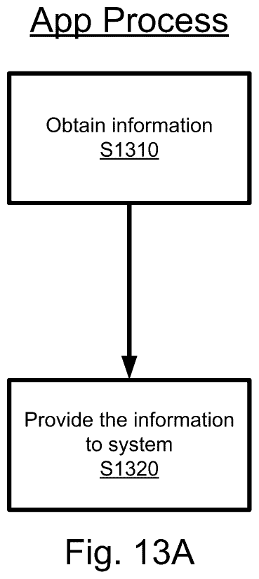

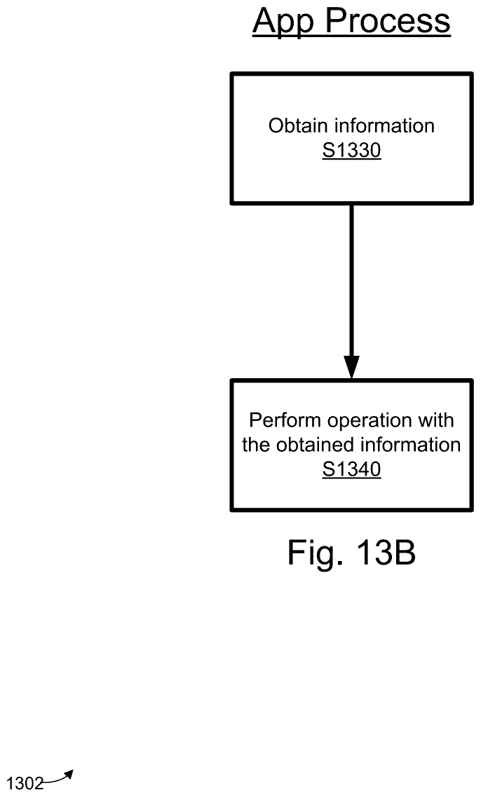

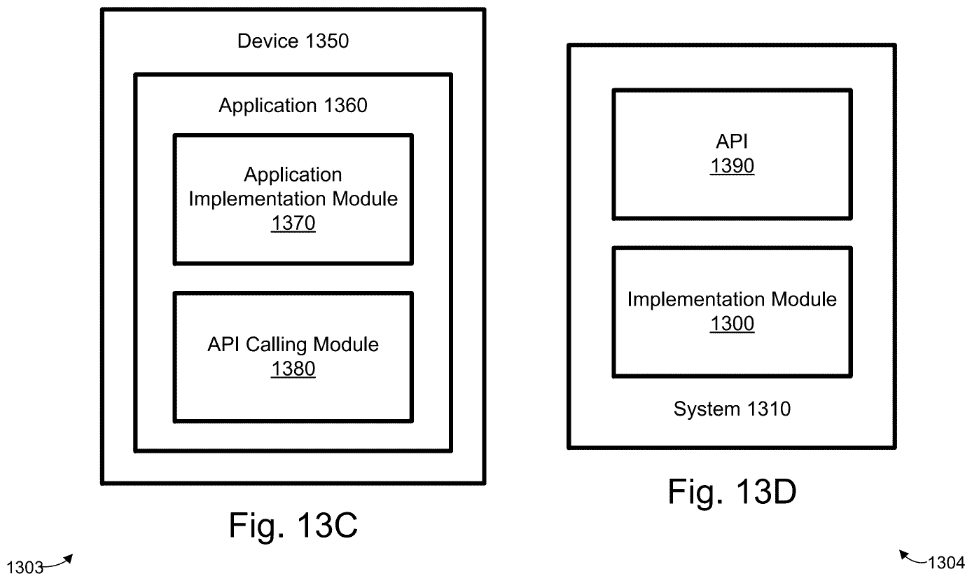

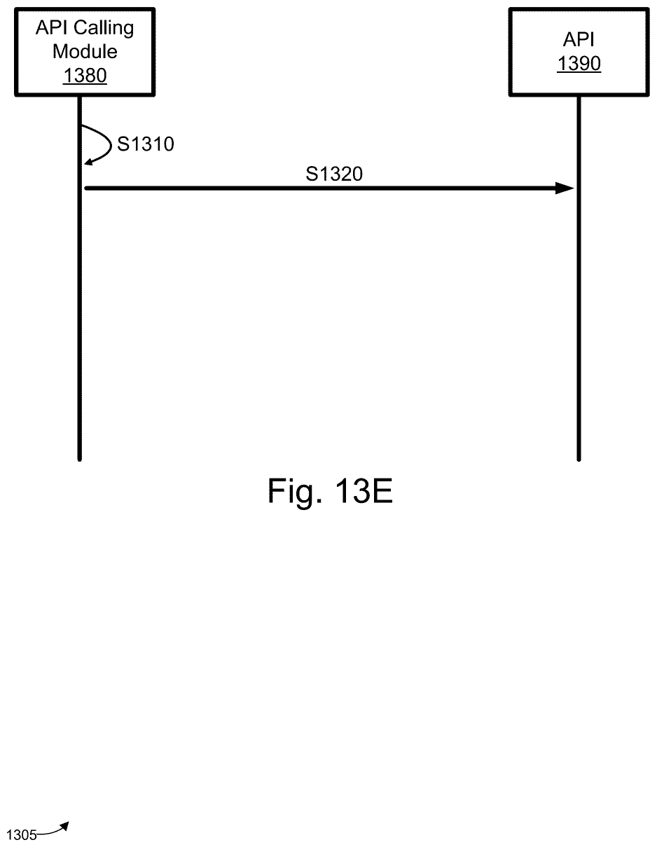

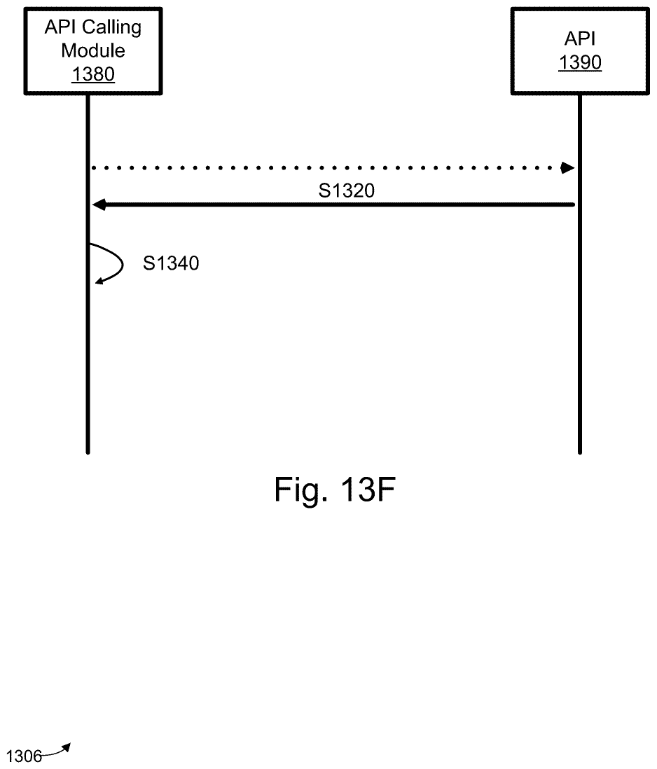

Implementations within the scope of the present disclosure include a computer-readable storage medium that encodes instructions organized as an application (e.g., application 1360) that, when executed by one or more processing units, control an electronic device (e.g., device 1350) to perform the method of FIG. 13A, the method of FIG. 13B, and/or one or more other processes and/or methods described herein.

It should be recognized that application 1360 (shown in FIG. 13C) can be any suitable type of application, including, for example, one or more of: an accessory companion application, a browser application, an application that functions as an execution environment for plug-ins, widgets or other applications, a fitness application, a health application, a digital payments application, a media application, a social network application, a messaging application, and/or a maps application. In some embodiments, application 1360 is an application that is pre-installed on device 1350 at purchase (e.g., a first party application). In other embodiments, application 1360 is an application that is provided to device 1350 via an operating system update file (e.g., a first party application or a second party application). In other embodiments, application 1360 is an application that is provided via an application store. In some embodiments, the application store can be an application store that is pre-installed on device 1350 at purchase (e.g., a first party application store). In other embodiments, the application store is a third-party application store (e.g., an application store that is provided by another application store, downloaded via a network, and/or read from a storage device).

Referring to FIG. 13A and FIG. 13E, application 1360 obtains information (e.g., S1310). In some embodiments, at S1310, information is obtained from at least one hardware component of the device 1350. In some embodiments, at S1310, information is obtained from at least one software module of the device 1350. In some embodiments, at S1310, information is obtained from at least one hardware component external to the device 1350 (e.g., a peripheral device, an accessory device, a server, etc.). In some embodiments, the information obtained at S1310 includes positional information, time information, notification information, user information, environment information, electronic device state information, weather information, media information, historical information, event information, hardware information, and/or motion information. In some embodiments, in response to and/or after obtaining the information at S1310, application 1360 provides the information to a system (e.g., S1320).

In some embodiments, the system (e.g., 1310 shown in FIG. 13D) is an operating system hosted on the device 1350. In some embodiments, the system (e.g., 1310 shown in FIG. 13D) is an external device (e.g., a server, a peripheral device, an accessory, a personal computing device, etc.) that includes an operating system.

Referring to FIG. 13B and FIG. 13F, application 1360 obtains information (e.g., S1330). In some embodiments, the information obtained at S1330 includes positional information, time information, notification information, user information, environment information electronic device state information, weather information, media information, historical information, event information, hardware information and/or motion information. In response to and/or after obtaining the information at S1330, application 1360 performs an operation with the information (e.g., S1340). In some embodiments, the operation performed at S1340 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 1310 based on the information.

In some embodiments, one or more steps of the method of FIG. 13A and/or the method of FIG. 13B is performed in response to a trigger. In some embodiments, the trigger includes detection of an event, a notification received from system 1310, a user input, and/or a response to a call to an API provided by system 1310.

In some embodiments, the instructions of application 1360, when executed, control device 1350 to perform the method of FIG. 13A and/or the method of FIG. 13B by calling an application programming interface (API) (e.g., API 1390) provided by system 1310. In some embodiments, application 1360 performs at least a portion of the method of FIG. 13A and/or the method of FIG. 13B without calling API 1390.

In some embodiments, one or more steps of the method of FIG. 13A and/or the method of FIG. 13B includes calling an API (e.g., API 1390) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 13C, device 1350 is illustrated. In some embodiments, device 1350 is a personal computing device, a smart phone, a smart watch, a fitness tracker, a head mounted display (HMD) device, a media device, a communal device, a speaker, a television, and/or a tablet. As illustrated in FIG. 13C, device 1350 includes application 1360 and operating system (e.g., system 1310 shown in FIG. 13D). Application 1360 includes application implementation module 1370 and API calling module 1380. System 1310 includes API 1390 and implementation module 1300. It should be recognized that device 1350, application 1360, and/or system 1310 can include more, fewer, and/or different components than illustrated in FIGS. 13C and 13D.

In some embodiments, application implementation module 1370 includes a set of one or more instructions corresponding to one or more operations performed by application 1360. For example, when application 1360 is a messaging application, application implementation module 1370 can include operations to receive and send messages. In some embodiments, application implementation module 1370 communicates with API calling module to communicate with system 1310 via API 1390 (shown in FIG. 13D).

In some embodiments, API 1390 is a software module (e.g., a collection of computer-readable instructions) that provides an interface that allows a different module (e.g., API calling module 1380) to access and/or use one or more functions, methods, procedures, data structures, classes, and/or other services provided by implementation module 1300 of system 1310. For example, API-calling module 1380 can access a feature of implementation module 1300 through one or more API calls or invocations (e.g., embodied by a function or a method call) exposed by API 1390 and can pass data and/or control information using one or more parameters via the API calls or invocations. In some embodiments, API 1390 allows application 1360 to use a service provided by a Software Development Kit (SDK) library. In other embodiments, application 1360 incorporates a call to a function or method provided by the SDK library and provided by API 1390 or uses data types or objects defined in the SDK library and provided by API 1390. In some embodiments, API-calling module 1380 makes an API call via API 1390 to access and use a feature of implementation module 1300 that is specified by API 1390. In such embodiments, implementation module 1300 can return a value via API 1390 to API-calling module 1380 in response to the API call. The value can report to application 1360 the capabilities or state of a hardware component of device 1350, including those related to aspects such as input capabilities and state, output capabilities and state, processing capability, power state, storage capacity and state, and/or communications capability. In some embodiments, API 1390 is implemented in part by firmware, microcode, or other low level logic that executes in part on the hardware component.

In some embodiments, API 1390 allows a developer of API-calling module 1380 (which can be a third-party developer) to leverage a feature provided by implementation module 1300. In such embodiments, there can be one or more API-calling modules (e.g., including API-calling module 1380) that communicate with implementation module 1300. In some embodiments, API 1390 allows multiple API-calling modules written in different programming languages to communicate with implementation module 1300 (e.g., API 1390 can include features for translating calls and returns between implementation module 1300 and API-calling module 1380) while API 1390 is implemented in terms of a specific programming language. In some embodiments, API-calling module 1380 calls APIs from different providers such as a set of APIs from an OS provider, another set of APIs from a plug-in provider, and/or another set of APIs from another provider (e.g., the provider of a software library) or creator of the another set of APIs.

Examples of API 1390 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API. In some embodiments the sensor API is an API for accessing data associated with a sensor of device 1350. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 1300 is an system (e.g., operating system, server system) software module (e.g., a collection of computer-readable instructions) that is constructed to perform an operation in response to receiving an API call via API 1390. In some embodiments, implementation module 1300 is constructed to provide an API response (via API 1390) as a result of processing an API call. By way of example, implementation module 1300 and API-calling module 180 can each be any one of an operating system, a library, a device driver, an API, an application program, or other module. It should be understood that implementation module 1300 and API-calling module 1380 can be the same or different type of module from each other. In some embodiments, implementation module 1300 is embodied at least in part in firmware, microcode, or other hardware logic.

In some embodiments, implementation module 1300 returns a value through API 1390 in response to an API call from API-calling module 1380. While API 1390 defines the syntax and result of an API call (e.g., how to invoke the API call and what the API call does), API 1390 might not reveal how implementation module 1300 accomplishes the function specified by the API call. Various API calls are transferred via the one or more application programming interfaces between API-calling module 1380 and implementation module 1300. Transferring the API calls can include issuing, initiating, invoking, calling, receiving, returning, and/or responding to the function calls or messages. In other words, transferring can describe actions by either of API-calling module 1380 or implementation module 1300. In some embodiments, a function call or other invocation of API 1390 sends and/or receives one or more parameters through a parameter list or other structure.

In some embodiments, implementation module 1300 provides more than one API, each providing a different view of or with different aspects of functionality implemented by implementation module 1300. For example, one API of implementation module 1300 can provide a first set of functions and can be exposed to third party developers, and another API of implementation module 1300 can be hidden (e.g., not exposed) and provide a subset of the first set of functions and also provide another set of functions, such as testing or debugging functions which are not in the first set of functions. In some embodiments, implementation module 1300 calls one or more other components via an underlying API and thus be both an API calling module and an implementation module. It should be recognized that implementation module 1300 can include additional functions, methods, classes, data structures, and/or other features that are not specified through API 1390 and are not available to API calling module 1380. It should also be recognized that API calling module 1380 can be on the same system as implementation module 1300 or can be located remotely and access implementation module 1300 using API 1390 over a network. In some embodiments, implementation module 1300, API 1390, and/or API-calling module 1380 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, any of methods 400 (FIGS. 4), 500 (FIGS. 5), 700 (FIG. 7), and 900 (FIG. 9) are performed at a first computer system (as described herein) via a system process (e.g., an operating system process, a server system process) that is different from one or more applications executing and/or installed on the first computer system.

In some embodiments, any of methods 400 (FIGS. 4), 500 (FIGS. 5), 700 (FIG. 7), and 900 (FIG. 9) are performed at a first computer system (as described herein) by an application that is different from a system process. In some embodiments, the instructions of the application, when executed, control the first computer system to perform any of methods 400 (FIGS. 4), 500 (FIGS. 5), 700 (FIG. 7), and 900 (FIG. 9) by calling an application programming interface (API) provided by the system process. In some embodiments, the application performs at least a portion of any of methods 400, 500, 700 and 900 without calling the API.

In some embodiments, the application is an accessory companion application that is constructed for processing communication and management between the first computer system and an accessory device (e.g., a wearable device, such as, for example, a watch).

In some embodiments, the application is an application that is pre-installed on the first computer system at purchase (e.g., a first party application). In other embodiments, the application is an application that is provided to the first computer system via an operating system update file (e.g., a first party application). In other embodiments, the application is an application that is provided via an application store. In some implementations, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform method 900 (FIG. 9) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. The implementation module is an system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 1350) that runs the application. In some embodiments, the implementation module is included in an electronic device that is separate from the device that runs the application.

### X. Example Device

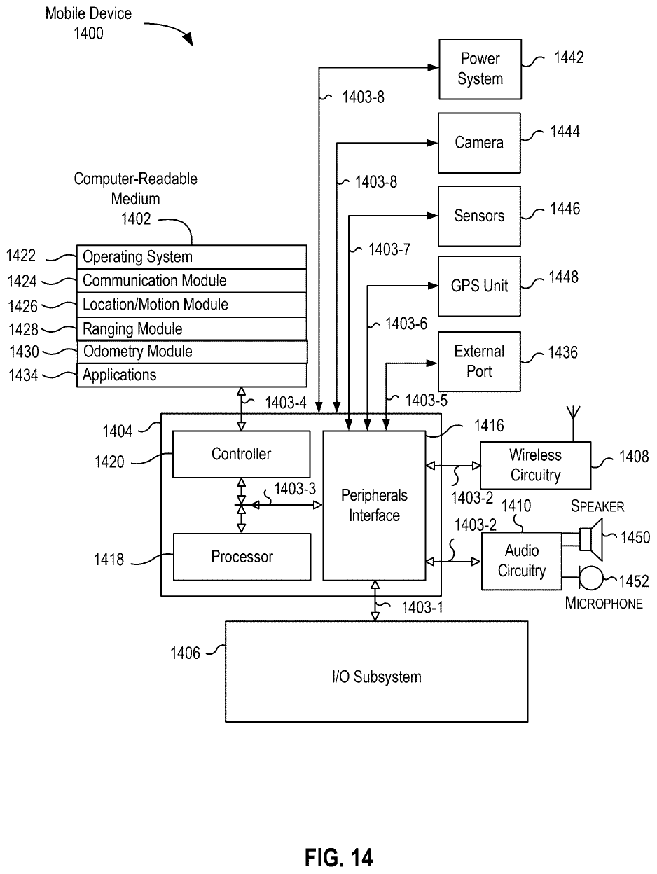

FIG. 14 is a block diagram of an example electronic device 1400 according to at least one embodiment. Device 1400 generally includes computer-readable medium 1402, a processing system 1404, an Input/Output (I/O) subsystem 1406, wireless circuitry 1408, and audio circuitry 1410 including speaker 1412 and microphone 1414. These components may be coupled by one or more communication buses or signal lines 1403. Device 1400 can be any portable electronic device, including a handheld computer, a tablet computer, a mobile phone, laptop computer, tablet device, media player, personal digital assistant (PDA), a key fob, a car key, an access card, a multifunction device, a mobile phone, a portable gaming device, a headset, or the like, including a combination of two or more of these items.

it should be apparent that the architecture shown in FIG. 14 is only one example of an architecture for device 1400, and that device 1400 can have more or fewer components than shown, or a different configuration of components. The various components shown in FIG. 14 can be implemented in hardware, software, or a combination of both hardware and software, including one or more signal processing and/or application specific integrated circuits.

Wireless circuitry 1408 is used to send and receive information over a wireless link or network to one or more other devices' conventional circuitry such as an antenna system, a radio frequency (RF) transceiver, one or more amplifiers, a tuner, one or more oscillators, a digital signal processor, a coder-decoder (CODEC) chipset, memory, etc. Wireless circuitry 1408 can use various protocols, e.g., as described herein. In various embodiments, wireless circuitry 1408 is capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), LTE-Advanced, Wi-Fi (such as Institute of Electrical and Electronics Engineers (IEEE) 902.11a, IEEE 902.11b, IEEE 902.11g and/or IEEE 902.11n), Bluetooth, Wi-MAX, Voice Over Internet Protocol (VOIP), near field communication protocol (NFC), a protocol for email, instant messaging, and/or a short message service (SMS), or any other suitable communication protocol, including communication protocols not yet developed as of the filing date of this document.

Wireless circuitry 1408 is coupled to processing system 1404 via peripherals interface 1416. Peripherals interface 1416 can include conventional components for establishing and maintaining communication between peripherals and processing system 1404. Voice and data information received by wireless circuitry 1408 (e.g., in speech recognition or voice command applications) is sent to one or more processors 1418 via peripherals interface 1416. One or more processors 1418 are configurable to process various data formats for one or more application programs 1434 stored on medium 1402.

Peripherals interface 1416 couple the input and output peripherals of device 1400 to the one or more processors 1418 and computer-readable medium 1402. One or more processors 1418 communicate with computer-readable medium 1402 via a controller 1420. Computer-readable medium 1402 can be any device or medium that can store code and/or data for use by one or more processors 1418. Computer-readable medium 1402 can include a memory hierarchy, including cache, main memory and secondary memory. The memory hierarchy can be implemented using any combination of random access memory (RAM) (e.g., static random access memory (SRAM,) dynamic random access memory (DRAM), double data random access memory (DDRAM)), read only memory (ROM), FLASH, magnetic and/or optical storage devices, such as disk drives, magnetic tape, CDs (compact disks) and DVDs (digital video discs). In some embodiments, peripherals interface 1416, one or more processors 1418, and controller 1420 can be implemented on a single chip, such as processing system 1404. In some other embodiments, they can be implemented on separate chips.

Processor(s) 1418 can include hardware and/or software elements that perform one or more processing functions, such as mathematical operations, logical operations, data manipulation operations, data transfer operations, controlling the reception of user input, controlling output of information to users, or the like. Processor(s) 1418 can be embodied as one or more hardware processors, microprocessors, microcontrollers, field programmable gate arrays (FPGAs), application-specified integrated circuits (ASICs), or the like.

Device 1400 also includes a power system 1442 for powering the various hardware components. Power system 1442 can include a power management system, one or more power sources (e.g., battery, alternating current (AC)), a recharging system, a power failure detection circuit, a power converter or inverter, a power status indicator (e.g., a light emitting diode (LED)) and any other components typically associated with the generation, management and distribution of power in mobile devices.

In some embodiments, device 1400 includes a camera 1444. In some embodiments, device 1400 includes sensors 1446. Sensors can include accelerometers, compass, gyrometer, pressure sensors, audio sensors, light sensors, barometers, and the like. Sensors 1446 can be used to sense location aspects, such as auditory or light signatures of a location.

In some embodiments, device 1400 can include a GPS receiver, sometimes referred to as a GPS unit 1448. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information.

One or more processors 1418 run various software components stored in medium 1402 to perform various functions for device 1400. In some embodiments, the software components include an operating system 1422, a communication module 1424 (or set of instructions), a location module 1426 (or set of instructions), a ranging module 1428 that is used as part of ranging operation described herein, and other application programs 1434 (or set of instructions).

Operating system 1422 can be any suitable operating system, including iOS, Mac OS, Darwin, Real Time Operating System (RTXC), LINUX, UNIX, OS X, WINDOWS, or an embedded operating system such as VxWorks. The operating system can include various procedures, sets of instructions, software components and/or drivers for controlling and managing general system tasks (e.g., memory management, storage device control, power management, etc.) and facilitates communication between various hardware and software components.

Communication module 1424 facilitates communication with other devices over one or more external ports 1436 or via wireless circuitry 1408 and includes various software components for handling data received from wireless circuitry 1408 and/or external port 1436. External port 1436 (e.g., universal serial bus (USB), FireWire, Lightning connector, 70-pin connector, etc.) is adapted for coupling directly to other devices or indirectly over a network (e.g., the Internet, wireless local area network (LAN), etc.).

Location/motion module 1426 can assist in determining the current position (e.g., coordinates or other geographic location identifiers) and motion of device 1400. Modern positioning systems include satellite based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module 1426 receives data from GPS unit 1448 and analyzes the signals to determine the current position of the mobile device. In some embodiments, location/motion module 1426 can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry 1408 and is passed to location/motion module 1426. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for device 1400 based on the position coordinates of the corresponding transmitters. Regardless of the specific location technology used, location/motion module 1426 receives information from which a location fix can be derived, interprets that information, and returns location information, such as geographic coordinates, latitude/longitude, or other location fix data

Ranging module 1428 can send/receive ranging messages to/from an antenna, e.g., connected to wireless circuitry 1408. The messages can be used for various purposes, e.g., to identify a sending antenna of a device, determine timestamps of messages to determine a distance of electronic device 1400 from another device. Ranging module 1428 can exist on various processors of the device, e.g., an always-on processor (AOP), a UWB chip, and/or an application processor. For example, parts of ranging module 1428 can determine a distance on an AOP, and another part of the ranging module can interact with a sharing module, e.g., to display a position of the other device on a screen in order for a user to select the other device to share a data item. Ranging module 1428 can also interact with a reminder module that can provide an alert based on a distance from another mobile device.

Odometry module 1430 can perform odometry techniques to determine the location and orientation of electronic device 1400 within a physical environment. Output from the camera 1444 and the sensors 1446 can be accessed by the odometry module 1430, and the odometry module 1430 can use this information to perform visual inertial odometry techniques. The odometry module 1430 can identify and compare features in sequential images captured by camera 1444 to determine the camera's movement relative to those features. The odometry module 1430 may use information from the sequential images to create a map of the environment. In addition or alternatively, inertial information from sensors 1446 can be used to estimate the movement of the electronic device 1400. Inertial information can include any combination of linear acceleration, angular acceleration, linear velocity, angular velocity, and magnetometer readings, and the inertial information can be in any number of axes.

The one or more applications 1434 on device 1400 can include any applications installed on the device 1400, including without limitation, a browser, address book, contact list, email, instant messaging, social networking, word processing, keyboard emulation, widgets, JAVA-enabled applications, encryption, digital rights management, voice recognition, voice replication, a music player (which plays back recorded music stored in one or more files, such as MP3 or AAC files), etc.

There may be other modules or sets of instructions (not shown), such as a graphics module, a time module, etc. For example, the graphics module can include various conventional software components for rendering, animating and displaying graphical objects (including without limitation text, web pages, icons, digital images, animations and the like) on a display surface. In another example, a timer module can be a software timer. The timer module can also be implemented in hardware. The time module can maintain various timers for any number of events.

I/O subsystem 1406 can be coupled to a display system (not shown), which can be a touch-sensitive display. The display displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 1406 can include a display and user input devices such as a keyboard, mouse, and/or trackpad. In some embodiments, I/O subsystem 1406 can include a touch-sensitive display. A touch-sensitive display can also accept input from the user based at least part on haptic and/or tactile contact. In some embodiments, a touch-sensitive display forms a touch-sensitive surface that accepts user input. The touch-sensitive display/surface (along with any associated modules and/or sets of instructions in computer-readable medium 1402) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, I/O subsystem 1406 can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, device 1400 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g. a solid state drive, a hard drive, a CD, or an entire computer system), and may be present on or within different computer products within a system or network. A computer system may include a monitor, printer, or other suitable display for providing any of the results mentioned herein to a user.

As described above, one aspect of the present technology is the gathering, sharing, and use of data, including historical and predicted location visits and data from which the predicted visits are derived. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to help the user navigate, help the user find lost items, take location based actions, and to provide contextual location based suggestions. Further, other uses for personal information data that benefit the user are also contemplated by the present disclosure.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of sharing content and performing ranging, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

Although the present disclosure has been described with respect to specific embodiments, it will be appreciated that the disclosure is intended to cover all modifications and equivalents within the scope of the following claims.

All patents, patent applications, publications, and descriptions mentioned herein are incorporated by reference in their entirety for all purposes. None is admitted to be prior art.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure. The use of “or” is intended to mean an “inclusive or,” and not an “exclusive or” unless specifically indicated to the contrary. Reference to a “first” component does not necessarily require that a second component be provided. Moreover reference to a “first” or a “second” component does not limit the referenced component to a particular location unless expressly stated. The term “based on” is intended to mean “based at least in part on.”

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

Implementations within the scope of the present disclosure include a computer-readable storage medium that encodes instructions organized as an application that, when executed by one or more processing units, control an electronic device to perform any of the methods described herein.

It should be recognized that the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, the application is an application that is pre-installed on device at purchase (e.g., a first party application). In other embodiments, the application is an application that is provided to the device via an operating system update file (e.g., a first party application or a second party application). In other embodiments, the application is an application that is provided via an application store. In some embodiments, the application store can be an application store that is pre-installed on the device at purchase (e.g., a first party application store). In other embodiments, the application store is a third-party application store (e.g., an application store that is provided by another application store, downloaded via a network, and/or read from a storage device).

1. A method performed by a mobile device, the method comprising:
measuring, using one or more location protocols, location information of the mobile device over a historical time period;
determining, using the location information, a set of visited locations for use in an output layer of a location model;
generating the location model using the location information;
receiving a trigger to perform a location inference using the location model;
determining, from data stored on the mobile device, one or more current location-related data items; and
predicting one or more future locations of the mobile device over one or more future time intervals using the location model, one or more current location-related data items, and a current time.

2. The method of claim 1, wherein the location model is generated when the mobile device is charging.

3. The method of claim 2, wherein the generating the location model is initiated after the mobile device is charging for a threshold amount of time.

4. The method of claim 1, wherein the set of visited locations comprise one or more specific locations and one or more location categories.

5. The method of claim 4, wherein the one or more location categories include a first location category, and wherein predicting the one or more future locations includes:
determining a first specific location for the first location category based on one or more current location-related data items.

6. The method of claim 4, wherein the one or more location categories include a first location category corresponding to a transit state.

7. The method of claim 1, further comprising:
providing a notification based on the one or more future locations.

8. The method of claim 7, further comprising:
presenting the notification on a display of the mobile device.

9. The method of claim 7, wherein the notification is provided to a map application of the mobile device, the method further comprising:
initiating, by the map application, a navigation session to a location of the one or more future locations, wherein the navigation session is initiated in response to the notification.

10. The method of claim 7, wherein the notification is provided to an electronic device at a location of the one or more future locations, and wherein the electronic device performs a preparatory action in response to the notification.

11. The method of claim 10, wherein the electronic device is a thermostat and the preparatory action comprises:
controlling a heating element or a cooling element to cause a temperature change.

12. The method of claim 1, wherein the location model is a first location model of a plurality of location models, the method further comprising:
predicting, using one or more other location models of the plurality of location models, one or more other future locations of the mobile device over the one or more future time intervals; and
combining the one or more future locations and the one or more other future locations to determine one or more final future locations.

13. The method of claim 12, wherein the one or more other location models use the one or more current location-related data items.

14. The method of claim 1, further comprising:
determining a current location of the mobile device, wherein predicting the one or more future locations of the mobile device over the one or more future time intervals uses a difference between the current location and one or more future locations.

15. The method of claim 1, further comprising:
determining a motion trajectory of the mobile device, wherein predicting the one or more future locations of the mobile device over the one or more future time intervals uses the motion trajectory.

16-45. (canceled)

46. An electronic device, comprising:
one or more processors; and
a memory coupled to the one or more processors, the memory storing instructions that cause the one or more processors to perform a method comprising:
measuring, using one or more location protocols, location information of the electronic device over a historical time period;
determining, using the location information, a set of visited locations for use in an output layer of a location model;
generating the location model using the location information;
receiving a trigger to perform a location inference using the location model;
determining, from data stored on the electronic device, one or more current location-related data items; and
predicting one or more future locations of the electronic device over one or more future time intervals using the location model, one or more current location-related data items, and a current time.

47. A non-transitory computer readable medium storing instructions that when executed on one or more processors perform a method comprising:
measuring, using one or more location protocols, location information of a mobile device over a historical time period;
determining, using the location information, a set of visited locations for use in an output layer of a location model;
generating the location model using the location information;
receiving a trigger to perform a location inference using the location model;
determining, from data stored on the mobile device, one or more current location-related data items; and
predicting one or more future locations of the mobile device over one or more future time intervals using the location model, one or more current location-related data items, and a current time.

48. The electronic device of claim 46, wherein the location model is a first location model of a plurality of location models, the method further comprising:
predicting, using one or more other location models of the plurality of location models, one or more other future locations of the electronic device over the one or more future time intervals; and
combining the one or more future locations and the one or more other future locations to determine one or more final future locations.

49. The non-transitory computer readable medium of claim 47, wherein the location model is a first location model of a plurality of location models, the method further comprising:
predicting, using one or more other location models of the plurality of location models, one or more other future locations of the mobile device over the one or more future time intervals; and
combining the one or more future locations and the one or more other future locations to determine one or more final future locations.

50. The non-transitory computer readable medium of claim 47, further comprising:
determining a current location of the mobile device, wherein predicting the one or more future locations of the mobile device over the one or more future time intervals uses a difference between the current location and one or more future locations.
